(19) United States
(12) Patent Application Publication
(10) Pub. No.: US 2017/0372473 A1
(43) Pub. Date: Dec. 28, 2017

(54) MEDICAL IMAGING DIAGNOSIS APPARATUS AND MEDICAL IMAGING PROCESSING APPARATUS

(71) Applicant: TOSHIBA MEDICAL SYSTEMS CORPORATION, Otawara-shi (JP)

(72) Inventors: Hirotaka UJIIE, Otawara (JP); Kento Wakayama, Nasushiobara (JP); Makoto Yonezawa, Utsunomiya (JP)

(73) Assignee: TOSHIBA MEDICAL SYSTEMS CORPORATION, Otawara-shi (JP)

(21) Appl. No.: 15/626,988

(22) Filed: Jun. 19, 2017

(30) Foreign Application Priority Data
Jun. 22, 2016 (JP) 2016-123625
May 1, 2017 (JP) 2017-091215

(51) Int. Cl. G06T 7/00; G06F 3/0482

(52) U.S. Cl. CPC G06T 7/0012; G06F 3/0482; G06T 2200/24

(57) ABSTRACT

A medical imaging diagnosis apparatus includes a memory and processing circuitry. The memory stores display settings corresponding to multiple body parts of a subject. The processing circuitry accepts a setting of a display target of the body part based on an input operation. The processing circuitry detects the body part of the subject based on volume data of the subject. The processing circuitry generates a display image of the display target by applying the display setting which corresponds to the body part to the volume data, by reading out from the memory. The processing circuitry displays the display image data on a monitor.

### CROSS-REFERENCE TO RELATED APPLICATIONS

This application is based upon and claims the benefit of priority from Japanese Patent Application No. 2016-123625, filed on Jun. 22, 2016; and Japanese Patent Application No. 2017-091215, filed on May 1, 2017, the entire contents of all of which are incorporated herein by reference.

### FIELD

The present invention relates to a medical imaging diagnosis apparatus and a medical imaging processing apparatus.

### BACKGROUND

Several manual procedures are needed for displaying an image for diagnosis from volume data which is scanned three-dimensionally in a background medical imaging diagnosis apparatus. For instance, in a case of displaying a SVR (Shaded Volume Rendering) image of a target diagnosis body part within a whole body volume data scanned by an X-ray CT (Computed Tomography) apparatus, the following procedures are performed by a radiologist.

At first, a radiologist seeks a slice position which depicts a target body part by confirming and switching multiple slice images of volume data. After that, the SVR image of the target body part is displayed, by setting rendering parameters such as opacity or a coloring corresponding to the target body part, and by processing a rendering procedure of a three-dimensional area that includes the slice position. Further, if there is a notable region inside the target body part, a radiologist adjusts displaying settings by zooming, panning, or rotating the SVR image.

Further, for instance, by displaying a thumbnail image that displays a scanned part on a human model image in each scan, if an intended scan result is selected from a scan result list, a technique to support the selection operation from the list has been proposed. Further, a technique to support the interpretation of image data by displaying the anatomical landmarks detected by a medical image data by mapping onto the human model image has also been proposed.

### BRIEF DESCRIPTION OF THE DRAWINGS

FIG. 1 shows a configuration example of a medical information processing system according to a first embodiment;

FIG. 2 shows a configuration example of an X-ray CT apparatus according to the first embodiment;

FIG. 3 is a diagram for explaining the scanning of a three-dimensional scanogram by scan controlling circuitry according to the first embodiment;

FIG. 4A is a diagram for explaining an example detection procedure of the body part by the detecting function according to the first embodiment;

FIG. 4B is a diagram for explaining an example detection procedure of the body part by the detecting function according to the first embodiment;

FIG. 5 is a diagram for explaining an example detection procedure of the body part by the detecting function according to the first embodiment;

FIG. 6 is a diagram for explaining an example detection procedure of the body part by the detecting function according to the first embodiment;

FIG. 7 is a diagram of an example human model image stored by the memory according to the first embodiment;

FIG. 8 is a diagram for explaining an example procedure of position matching by the positional matching function according to the first embodiment;

FIG. 9 is a diagram for explaining an example conversion of a scanning region by the coordinate conversion method according to the first embodiment;

FIG. 10 is an example diagram of displaying settings list according to the first embodiment;

FIG. 11 is a list of displaying settings according to the first embodiment;

FIG. 12 is a diagram for explaining a procedure of input/output controlling function according to the first embodiment;

FIG. 13A is a diagram for explaining a procedure of a display controlling function according to the first embodiment;

FIG. 13B is a diagram for explaining a procedure of a display controlling function according to the first embodiment;

FIG. 14 is a flowchart for explaining a procedure by an X-ray CT apparatus according to the first embodiment; FIG. 15 is a flowchart for explaining a procedure by an

X-ray CT apparatus according to the first embodiment;

FIG. 16A is a diagram for explaining effects of an X-ray CT apparatus according to the first embodiment;

FIG. 16B is a diagram for explaining effects of an X-ray CT apparatus according to the first embodiment;

FIG. 16C is a diagram for explaining effects of an X-ray CT apparatus according to the first embodiment;

FIG. 17 is a diagram for explaining a procedure of input/output controlling function according to a first variation of the first embodiment;

FIG. 18 is a diagram for explaining a procedure of input/output controlling function according to a second variation of the first embodiment;

FIG. 19 is a diagram for explaining a procedure of input/output controlling function and generating function according to a second embodiment;

FIG. 20 is a configuration example of processing circuitry according to a third embodiment;

FIG. 21 is a diagram for explaining a post-processing in each body part by the memory according to the third embodiment;

FIG. 22 is a diagram for explaining a procedure of display controlling function according to the third embodiment;

FIG. 23 is a flowchart for explaining a procedure by an X-ray CT apparatus according to the third embodiment;

### DETAILED DESCRIPTION

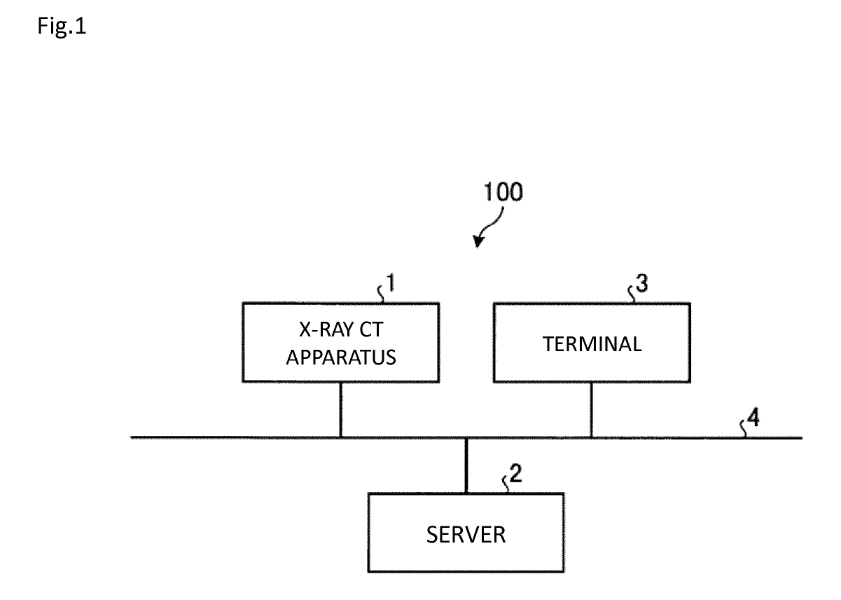

A medical imaging diagnosis apparatus and a medical imaging processing apparatus according to embodiments are explained below with reference to the drawings. A medical information processing system including an X-ray CT (Computed Tomography) apparatus is explained in the following embodiment as an example of a medical imaging diagnosis apparatus. As other examples of medical imaging diagnosis apparatus, an X-ray diagnosis apparatus, a MRI (Magnetic Resonance Imaging) apparatus, a SPECT (Single Photon Emission Computed Tomography) apparatus, a PET (Positron Emission Computed Tomography) apparatus, a SPECT-CT apparatus which consisted by a SPECT apparatus and an X-ray CT apparatus, a PET-CT apparatus of a PET apparatus and an X-ray CT apparatus, and any of these plurality of apparatuses can be applied. Further, a server 2 and a terminal 3 are shown in a medical information processing system in FIG. 1, but it is possible to include multiple servers 2 and terminals 3 in the medical information processing device 100.

FIG. 1 shows a configuration example of a medical information processing system 100 according to a first embodiment. As shown in FIG. 1, the medical information processing system 100 according to the first embodiment includes an X-ray CT apparatus 1, server 2, and terminal 3. For example, the X-ray CT apparatus 1, the server 2, and the terminal 3 are in a condition to communicate with each device directly or indirectly by a network 4 in a hospital. For example, in case a PACS (Picture Archiving Communication System) is incorporated into the medical information processing system 100, the X-ray CT apparatus 1, the server 2, and the terminal 3 send and receive medical images based on the DICOM (Digital Imaging and Communication in Medicine) standard.

Further, in the medical information processing system 100, for example, a HIS (Hospital Information System) and RIS (Radiology Information System) are incorporated and various information are archived. For example, the terminal 3 sends inspection orders produced based on HIS and RIS information to the X-ray CT apparatus 1 and the server 2. The X-ray CT apparatus collects X-ray CT image data in each patient, by acquiring a patient information by inspection orders directly sent by terminal 3, or a patient list in each modality (modality work list) produced by the server 2 which receives the inspection orders. Further, the X-ray CT apparatus 1 sends an acquired X-ray CT image data or an image data generated by performing various image processing by the X-ray CT image data to the server 2. The server 2 includes a memory to store the X-ray CT image data and the image data received from the X-ray CT apparatus 1 and generates an image data from the X-ray CT image data. The server 2 also sends the image data based on the request information from the terminal 3. The terminal 3 displays the received image data from the server 2. The details of each device are explained below.

The terminal 3 is a device, such as a PC (Personal Computer), tablet-type PC, PDA (Personal Digital Assistant), or cell-phone, which is operated by a doctor of each diagnosis and treatment department, installed at the diagnosis and treatment department in a hospital. For example, clinical records such as symptoms of the patient or doctor's diagnosis and observations are inputted by the doctor to the terminal 3. Further, the terminal 3 receives the inspection orders used by the X-ray CT apparatus 1 and sends the inspection orders to the X-ray CT apparatus 1 and the server 2. That is, by manipulating the terminal 3, the doctor references patient information and clinical records, examines the patient, and inputs clinical information to the clinical records. Further, the doctor operates the terminal 3 and sends the inspection orders depending on the necessity of inspection by X-ray CT apparatus 1.

The server 2, such as a PACS server including microprocessor circuits and memory circuits, stores medical images acquired by a medical imaging diagnosis apparatus (for example X-ray CT image data or an image data acquired by the X-ray CT apparatus 1), or performs various imaging processing to the acquired image data. For example, the server 2 receives multiple inspection orders from the terminal 3 installed in each clinical department, generates patient's lists in each medical imaging diagnosis apparatus, and sends the patient's list to each of the medical imaging diagnosis apparatus. For example, the server 2 receives inspection orders to perform an inspection by the X-ray CT apparatus 1 from the terminal 3, generates patient's lists, and sends the patient's lists to the X-ray CT apparatus 1. Further, the server 2 stores an X-ray CT image data and an image data acquired by the X-ray CT apparatus 1 and sends the X-ray CT image data and the image data to the terminal 3 in response to request information from the terminal 3.

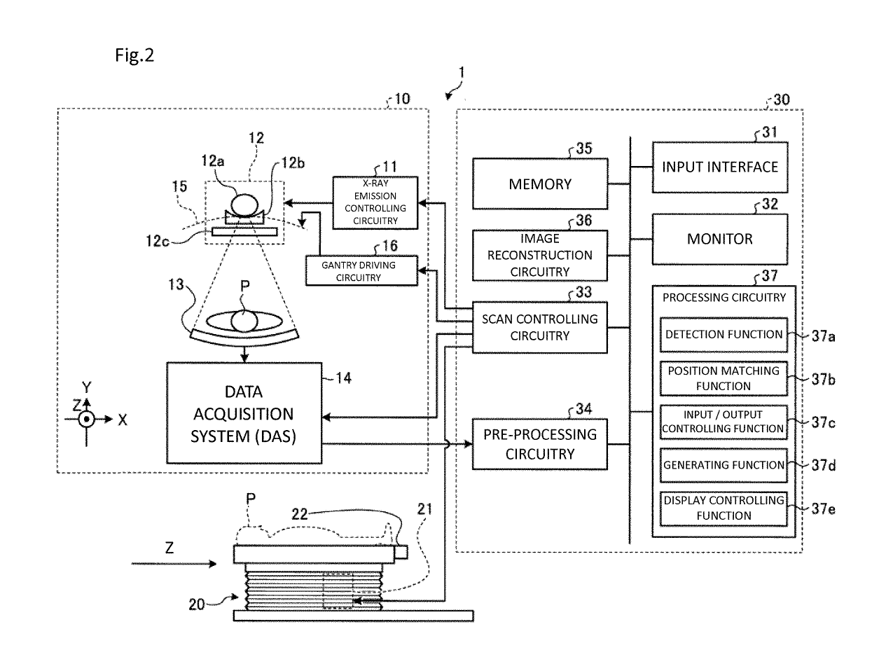

The X-ray CT apparatus 1 acquires an X-ray CT image data of each patient and sends image data generated by performing various imaging processing to the X-ray CT image data to a server 2. FIG. 2 shows a configuration example of the X-ray CT apparatus 1 according to the first embodiment. As shown in FIG. 2, the X-ray CT apparatus 1 includes a gantry 10, a bed 20, and a console 30.

The gantry 10 is a device which emits an X-ray to a subject P, detects the X-ray passed through the subject P, and outputs the detected X-ray to a console 30. The gantry 10 includes an X-ray emission controlling circuitry 11, an X-ray generator 12, detector 13, data acquisition system (DAS) 14, a rotating frame 15, and a gantry driving circuitry 16.

The rotating frame 15 is an annular frame that supports the X-ray generating apparatus 12 and the detector 13 so as to oppose each other sandwiching the subject P in between, and that is rotated by the gantry driving circuitry 16 as described below.

The X-ray emission controlling circuitry 11 supplies a high voltage to the X-ray tube 12a as a high voltage generator, and the X-ray tube 12a generates an X-ray by using the high voltage supplied by the X-ray emission controlling circuitry 11. That is, the X-ray emission controlling circuitry 11 adjusts an amount of an X-ray to be emitted to the subject P by adjusting a tube voltage and a tube current to be supplied to the X-ray tube 12a.

Furthermore, the X-ray emission controlling circuitry 11 controls a wedge 12b. In addition, the X-ray emission controlling circuitry 11 adjusts an X-ray irradiation range (fan angle and/or cone angle) by adjusting the opening degree of collimator 12c. Further, various kinds of the wedge 12b can be switched by manual operation in this embodiment.

The X-ray generating apparatus 12 is an X-ray source that emits a generated X-ray to the subject P. The X-ray generating apparatus 12 includes the X-ray tube 12a, the wedge 12b, and the collimator 12c.

The X-ray tube 12a is a vacuum tube that irradiates the subject P with an X-ray beam by high voltage supplied by the high voltage generator along with rotation of a rotation frame 15. The X-ray tube 12a generates the X-ray beam which has a fan angle and cone angle. For example, the X-ray tube 12a can emit an X-ray continuously at all of the circumference of the subject P for full reconstruction or part of the circumference of the subject P (such as 180 degree+fan angle) for half reconstruction controlled by the X-ray emission controlling circuitry 11. Further, controlled by the X-ray emission controlling circuitry 11, the X-ray tube 12 can emit the X-ray intermittently (a pulsed X-ray) at a predetermined position (the position of the X-ray tube 12a). Further, the X-ray emission controlling circuitry 11 can also modulate the intensity of an X-ray emitted from the X-ray tube 12a. For example, the X-ray emission controlling circuitry 11 can heighten the intensity of the X-ray emitted from the X-ray tube 12a at a certain position of the X-ray tube 12 and lower the intensity of the X-ray emitted from the X-ray tube 12a except at the certain position of the X-ray tube 12.

The wedge 12b is an X-ray filter to adjust the amount of an X-ray emitted from the X-ray tube 12a. Specifically, the wedge 12b is a filter for attenuating the X-ray emitted from the X-ray tube 12a by passing the X-ray inside itself, to shape the X-ray by a predetermined distribution which is emitted to the subject P. For example, the wedge 12b is a processed aluminum filter to formulate the X-ray that has a predetermined target angle and width. Further, the wedge 12b can be a wedge filter or a bow-tie filter.

The collimator 12c is a slit to focus the X-ray irradiation range adjusted by the wedge 12b controlled by the X-ray emission controlling circuitry 11.

The gantry driving circuitry 16 rotates the X-ray generating device 12 and the detector 13 along an orbit around the subject P as a center by driving the rotating frame 15 to be rotated.

The detector 13 includes two dimensional array detectors (area detectors) which detect an X-ray passed through the subject P. The detector 13 includes plural detecting devices in a row for channel direction and these detecting devices in the row are aligned to the Z axis direction. Specifically, the detector 13 in the first embodiment includes a plurality of X-ray detection component rows (for example 320 rows) along the Z axis. For example, the detector 13 can cover a wide range of the X-ray passed through the subject P, such as a region including the lung or heart of subject P. Further, the Z axis corresponds to the rotation axis direction of the rotating frame 15 in a case of a non-tilt phase of the gantry 10.

The data acquisition system 14 (DAS) is circuitry that acquires a projection data by detection data detected by detector 13. For example, the data acquisition system 14 produces a projection data by performing an amplification processing, analog to digital conversion processing, and sensitivity correction, and sends the generated projection data to the console 30, as described later in detail. For example, in a case the X-rays are emitted continuously from the X-ray tube 12a during the rotating time of rotating frame 15, the data acquisition system 14 acquires whole circumferential (360 degree) projection data. Further, the data acquisition system 14 associates the acquired projection data with the X-ray tube position, and sends the projection data to the console 30, as described later in detail. The X-ray tube position is information which indicates the projection direction of projection data. Further, the sensitivity correction between channels can be performed by pre-processing circuitry 34 as described later.

The bed 20 is a device for loading the subject P on it and includes a bed driving apparatus 21 and a table 22 as shown in FIG. 2. The bed driving apparatus 21 moves the subject Pinto the rotating frame 15 by moving the table 22 in the Z direction. The table 22 is a plate for placing the subject P on itself.

Further, for example, the gantry 10 performs a helical scan by scanning the subject P spirally by moving the table 22 and rotating the rotating frame 15. Or, the gantry 10 performs a conventional scan by scanning the subject P by a circular orbit with fixing the subject P after the movement of the table 22. Or, the gantry 10 performs a step and shoot scan by performing the conventional scan in multiple scanning regions by moving the table 22 position a constant distance.

The console 30 accepts an operation of the X-ray CT apparatus by the user, and reconstructs X-ray CT image data using acquired projection data by the gantry 10. The console 30 includes an input interface 31, monitor 32, scan controlling circuitry 33, pre-processing circuitry 34, memory 35, image reconstruction circuitry 36, and processing circuitry 37.

The input interface 31 includes, for example, a mouse, keyboard, trackball, switch, button, and joystick, for inputting instructions and settings by a user of the X-ray CT apparatus 1 and transferring the instructions and settings to the processing circuitry 37 accepted from the user. For example, the input interface 31 accepts scan conditions of the X-ray CT apparatus 1, reconstruction conditions in a case of reconstructing the X-ray CT image data, and image processing conditions to the X-ray CT image data. Further, the input interface 31 accepts an operation for selecting the inspection for the subject P. Further, the input interface 31 accepts an operation for selecting a region on the image.

The monitor 32 is a monitor referenced by the user. The monitor 32 displays an image generated by the X-ray CT image data controlled by the processing circuitry 37 or displays a GUI (Graphical User Interface) for accepting various instructions and settings from the user by using the input interface 31. Further, the monitor 32 displays scan planning screens or scan processing screens. Further, the monitor 32 displays a human model image including the radiation exposure information, and image data. The human model image displayed on the monitor 32 is described later in detail.

The scan controlling circuitry 33 controls the acquisition processing of projection data by the gantry 10, by controlling the movement of the X-ray emission controlling circuitry 11, the gantry driving circuitry 16, the data acquisition system 14, and the bed driving apparatus 21 controlled by the processing circuitry 37. Specifically, the scan controlling circuitry 33 controls the acquisition processing of projection data for both positioning scan for acquiring the positioning image (scano image) and main scan for acquiring the image for diagnosis. In the X-ray CT apparatus 1 according to the first embodiment, the X-ray CT apparatus 1 can scan both a 2D and 3D scano image.

For example, the scan controlling circuitry 33 scans a 2D scano image by scanning continuously with moving the table 22 at a constant speed, with the X-ray tube 12a fixed at 0 degree (the front direction position for the subject P). Or, the scan controlling circuitry 33 scans the 2D scano image by repeating the scan intermittently synchronized with the movement of table 22 by moving the table 22 intermittently with the X-ray tube 12a fixed at 0 degree. Here, the scan controlling circuitry 33 can scan the positioning image not only from the front direction of the subject P, but also from any arbitrary direction (for example a side direction).

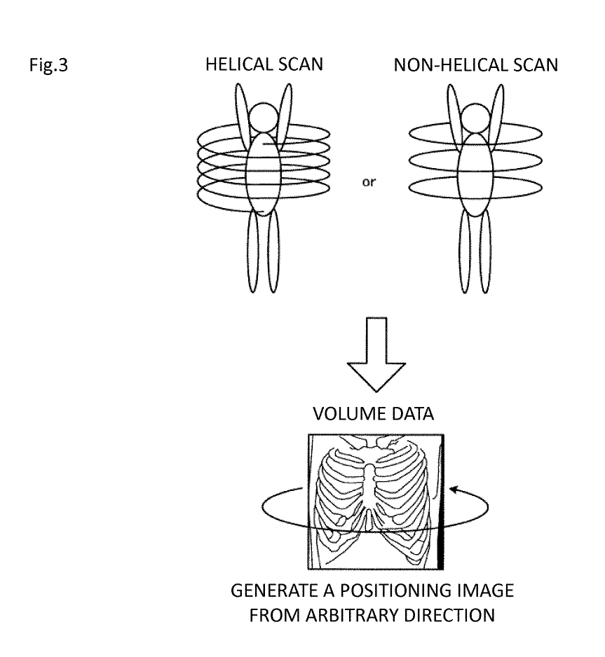

Furthermore, the scan controlling circuitry 33 scans a 3D scano image, by acquiring the whole circumference projection data of the subject P. FIG. 3 is a diagram for explaining a scanning of 3D scano by the scan controlling circuitry 33 according to the first embodiment. For example, the scan controlling circuitry 33, as shown in the FIG. 3, acquires the whole circumference projection data of the subject P by a helical scan or non-helical scan. Here, the scan controlling circuitry 33 performs the helical scan or non-helical scan with lower radiation exposure than that of the main scan for a wide range area such as the whole breast, abdomen, bust, and whole body of the subject P. As the non-helical scan, for example, the above-mentioned step and shoot scan can be performed.

Thus, the whole circumference projection data of the subject P is acquired by the scan controlling circuitry 33, and the image reconstruction circuitry 36 described later in detail can reconstruct 3D X-ray CT image data (volume data). Thereafter, as shown in FIG. 3, an arbitrary direction of a positioning image can be generated by using the reconstructed volume data. Here, the user can freely decide whether the positioning image can be scanned in 2D or 3D, or it can be predetermined depending on inspections.

Returning to FIG. 2, the pre-processing circuitry 34 generates corrected projection data by performing correction processing such as logarithm conversion processing, offset processing, sensitivity processing, and beam-hardening processing to the acquired projection data by the data acquisition system 14. Specifically, the pre-processing circuitry 34 generates corrected projection data corresponding to the projection data for a positioning image and main scan generated by data acquisition system 14.

The memory 35 stores the generated projection data by the pre-processing circuitry 34. Specifically, the memory 35 stores the generated projection data for the positioning image and main scan for diagnosis by the pre-processing circuitry 34. Further, the memory 35 stores the image data generated by the image reconstruction circuitry 36 described later, and the human model image. Further, the memory 35 stores the processing results by the processing circuitry 37 as described later. The human model image and the processing results by the processing circuitry 37 are described later.

For example, the memory 35 stores the 3D image data (volume data) of the multiple body parts of the subject P by a detecting function 37a. For example, the memory 35 stores information that includes the volume data of the subject's P body and the detection results of each detected body part from the volume data. The detecting function 37a is described later in detail.

The image reconstruction circuitry 36 reconstructs an X-ray CT image by using the projection data stored by the memory 35. Specifically, the image reconstruction circuitry 36 reconstructs the X-ray CT image data based on projection data for positioning and diagnosis. Here, as a reconstruction method, various methods can be applied, for example, a back-projection processing. As a back-projection method, for example, a FBP (Filtered Back Projection) can be applied. Or, the image reconstruction circuitry 36 can reconstruct the X-ray CT image data by using the iterative reconstruction method.

Further, the image reconstruction circuitry 36 generates image data by performing various image processing to the X-ray CT image data. Thereafter, the image reconstruction circuitry 36 stores the reconstructed X-ray CT image data and generates image data by various image processing to the memory 35.

The processing circuitry 37 totally controls the X-ray CT apparatus 1, by controlling the movement of the gantry 10, the bed 20, and the console 30. Specifically, the processing circuitry 37 controls the CT scan performed by the gantry 10, controlling the scan controlling circuitry 33. Further, the processing circuitry 37 controls image reconstruction processing and image generation processing performed by the console 30 by controlling the image reconstruction circuitry 36. Thereafter, the processing circuitry 37 makes the monitor 32 display various image data stored in the memory 35.

Further, the processing circuitry 37 includes a detecting function 37a, a positional matching function 37b, an input/output controlling function 37c, a generating function 37d, and a display controlling function 37e as shown in FIG. 2. Here, the various processing functions of each component of the processing circuitry 37, the detecting function 37a, the positional matching function 37b, the input/output controlling function 37c, the generating function 37d, and the display controlling function 37e, are stored in the memory 35 as a program which can be performed by a computer. The processing circuitry 37 is processor circuitry that realizes the functions corresponding to the each program by reading out the various programs from the memory 35. Thus, the processing circuitry 37 which reads out the each program includes each function as shown in the diagram of the processing circuitry 37 in FIG. 2.

The detecting function 37a detects the positions of multiple body parts of the subject P in 3D image data (volume data) of the subject P. Specifically, the detecting function 37a detects body parts such as an organ included in the 3D X-ray CT image data reconstructed by the image reconstruction circuitry 36. For example, the detecting function 37a detects the body parts such as an organ based on anatomical landmarks at least from the volume data for positioning or diagnosis. Here, the anatomical landmarks mean points which indicate landmark points of a certain bone, vessel, neuron, lumen, etc. Thus, the detecting function 37a detects the body parts such as a bone, organ, vessel, neuron, or lumen included in the volume data by detecting the anatomical landmarks of the certain organ or bone. Further, the detecting function 37a can detect a position of ahead, neck, breast, abdomen, foot, etc. included in the volume data by detecting the anatomical landmarks of the human body. The body parts described in this embodiment can be a bone, organ, vessel, neuron, lumen, and their positions. The example of the detection of the body parts by the detecting function 37 is explained further below.

For example, the detecting function 37a detects the anatomical landmarks from a voxel value included in the volume data based on a positioning image or diagnosis image. Further, the detecting function 37a optimizes the positions of the landmarks extracted by the volume data by eliminating the incorrect landmarks from the landmarks of the extracted volume data, by comparing the landmark positions extracted by the volume data with the 3D position of anatomical landmarks based on the general information such as from a textbook. Thus, the detecting function 37a detects the body parts of the subject P included in the volume data. For example, the detecting function 37a extracts the anatomical landmarks included in the volume data by using a supervised machine learning algorithm. Here, the above-mentioned supervised machine learning algorithm is a constructed algorithm by using the multiple supervised image by manually positioning the correct anatomical landmarks, for example, a decision tree is available.

Further, the detecting function 37a optimizes the extracted landmarks by comparing the model which indicates the 3D positional relationship of anatomical landmarks in the human body with extracted landmarks. Here, the above-mentioned model is constructed by using the above-mentioned supervised image, for example, a point distribution model can be used. Thus, the detecting function 37a optimizes the landmarks by comparing the shape of the body parts, a positional relation, and a model which defines the specific position to the body part, based on multiple supervised images which manually position the correct anatomical landmarks with the extracted landmarks, by eliminating the incorrect anatomical landmarks.

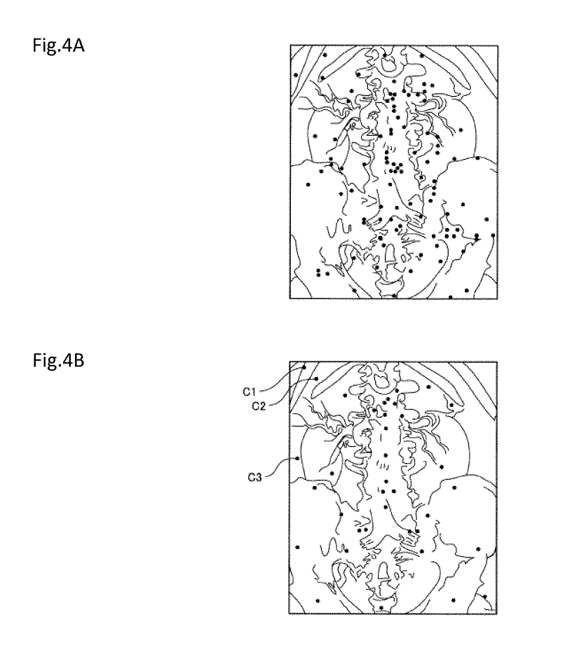

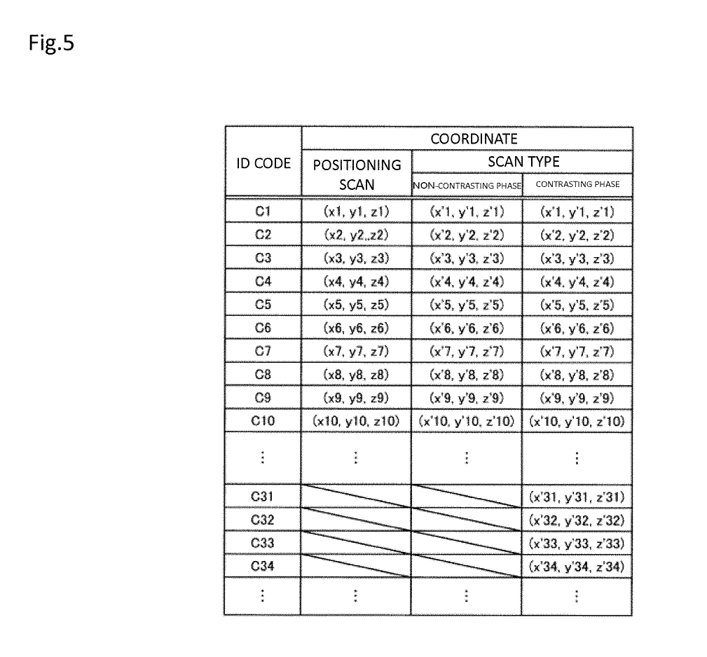

By referring to FIGS. 4A, 4B, 5, and 6, the detection procedure by the detecting function 37a is explained. FIGS. 4A, 4B, 5, and 6 are diagrams for explaining an example of a detection procedure of the body parts by the detecting function 37a. In FIG.4A and FIG.4B, the anatomical landmarks are positioned in 2D, however, the actual anatomical landmarks are positioned in 3D. For example, the detecting function 37a extracts a voxel regarded as the anatomical landmarks (black dots in FIGS. 4A and 4B) by applying the supervised machine learning algorithm to the volume data. Thereafter, the detecting function 37a extracts only one voxel corresponding to the more precise landmarks, by eliminating the incorrect landmarks from the extracted voxel as shown in FIG. 4B, by fitting the extracted voxel position with the model which defines the shape of the body part, positional relation, and the point specific to the body part.

Here, the detecting function 37a gives an ID code to the extracted landmarks (voxel) to identify the landmarks of the body parts. Further, the detecting function 37a stores the information which corresponds to the ID code and positional information (coordinate) in the memory 35. For example, the detecting function 37a attaches an ID code such as C1, C2, and C3 to the extracted landmarks (voxel) as shown in FIG. 4B. Here, the detecting function 37a attaches the ID code to the detection processing performed data and stores them in the memory 35. Specifically, the detecting function 37a detects the body parts of subject P, included in the reconstructed volume data based on at least one of the projection data within projection data for positioning image, projection data under a non-contrast procedure, and projection data under a contrast procedure.

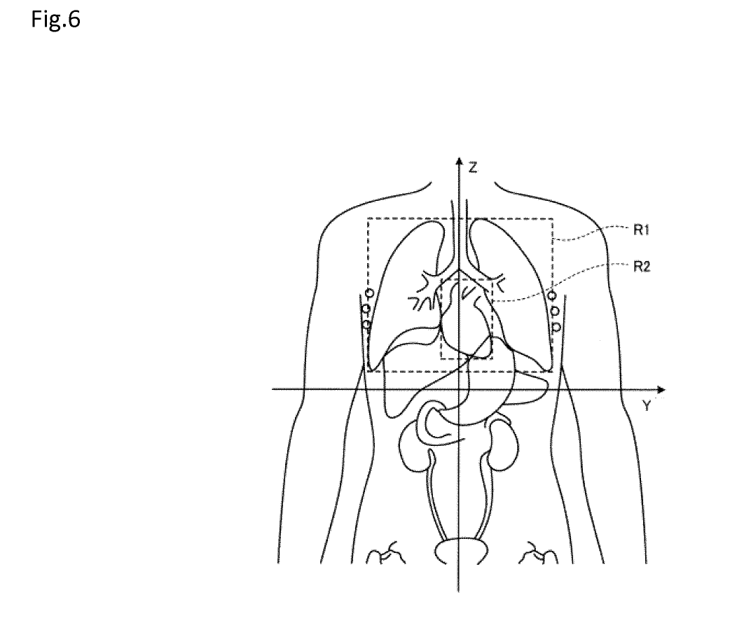

For example, the detecting function 37a stores the information which corresponding to each voxel's coordinate detected from the volume data corresponding to the ID code, as shown in FIG. 5. For example, the detecting function 37a extracts the coordinate of identification points from the volume data of the positioning image. Thereafter, as shown in FIG. 5, the detecting function 37a stores the ID code corresponding to the volume data such as “ID code:C1, coordinate (x1, y1, z1)” and “ID code:C2, coordinate (x2, y2, z2)”. Thus, the detecting function 37a can identify the position and the kinds of landmarks in the volume data of the positioning image. Therefore, the detecting function 37a can detect the body parts, such as the organ based on the information.

Further, the detecting function 37a, for example, as shown in the FIG. 5, stores the information corresponding to each coordinate of the voxel data detected by the volume data for diagnosis with the ID code in the memory 35. Here, the detecting function 37a can associate the extracted coordinate with the ID code by extracting the identification point coordinate based on the volume data with and without contrasting phase in the scan.

For example, the detecting function 37a extracts the coordinate of the landmarks from the non-contrast phase's volume data within the volume data for diagnosis. Thereafter, the detecting function 37a, as shown in the FIG. 5, stores the associated ID codes such as “ID code:C1, coordinate (x1, y1, z1)” and “ID code:C2, coordinate (x2, y2, z2)”. Further, the detecting function 37a extracts the coordinate of the landmarks from the contrast phase's volume data within the volume data for diagnosis. Thereafter, the detecting function 37a, as shown in FIG. 5, stores the associated ID codes such as “ID code:C1, coordinate (x1, y1, z1)” and “ID code:C2, coordinate (x2, y2, z2)”. Here, in the case of extracting the identification points from the contrast phase's volume data, the identification points which only can be extracted by contrast imaging are included. For example, the detecting function 37a can extract contrasted vessels and other organs by contrast medium, in the case of extracting the identification point from the contrast phase's volume data. Therefore, in the case the contrast phase's volume data is used, the detecting function 37a, as shown in FIG. 5, associates the ID codes such as C31, C32, C33, and C34 with the coordinates of the identification points of vessel such as (x′₃₁, Y′₃₁, Z′₃₁) to (x′₃₄, Y′₃₄, z′₃₄) extracted by contrasting.

As mentioned above, the detecting function 37a can identify the position and the kinds of the identification points in the volume data for the positioning image or for the diagnosis image. Thereafter, the detecting function 37a can detect each body part such as the organ based on the information. For example, the detecting function 37a detects the position of the target body part by using information of an anatomical position relation between the target body part for the target detection and a neighboring body part. For example, in the case the target body part is the “lung”, the detecting function 37a acquires the coordinate's information associated with ID codes which represent characteristics of the lung. At the same time, the detecting function 37a also acquires the coordinate's information associated with the ID code which represents the lung's neighboring body parts, such as “rib”, “clavicle”, “heart” and “diaphragm”. Thereafter, the detecting function 37a extracts the region of the “ung exin the volume data by using the information of the anatomical positional relationship with the “lungh and the neighboring body part and the acquired coordinate information.

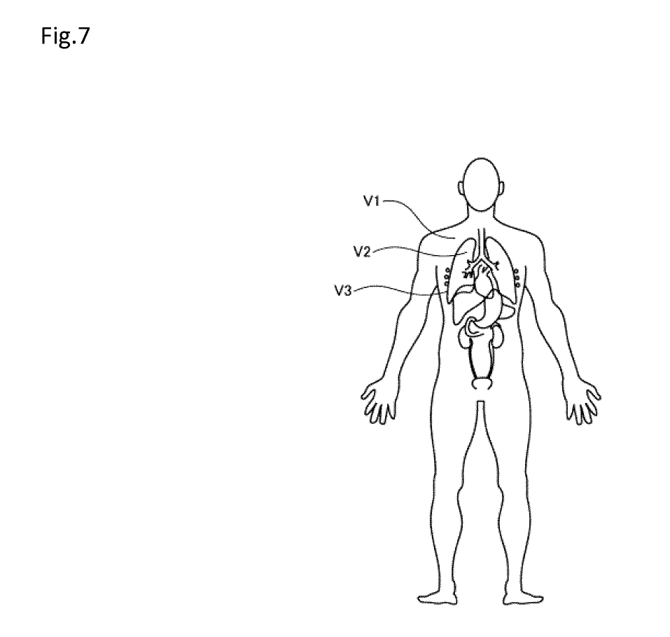

For example, as shown in FIG. 6, the detecting function 37a extracts a certain region “R1” corresponding to the “lung” in the volume data, by using the positional relationship information such as “Apex: above 2˜3 cm of clavicle” and “Lower edge: the height of the 7^{th} rib” and coordinate's information of the body parts. Thus, the detecting function 37a extracts the coordinate's information of voxel of R1 in the volume data. The detecting function 37a stores the extracted coordinate's information and body part's information attached with the volume data in the memory 35. Similarly, the detecting function 37a, as shown in FIG. 6, extracts the region R2 corresponding to the “earttrain the volume data.

Further, the detecting function 37a detects the position included in the volume data based on the landmarks which define the positions of a body part in the human body, such as head or breast. Here, the position of body parts in human body such as head or breast can be defined arbitrarily. For example, if the breast is defined as from the 7^{th} cervical vertebra to the lower edge of lung, the detecting function 37a detects the landmarks from the 7^{th} cervical vertebra to lower edge of the lung. In addition, the detecting function 37a can detect the body parts by using various methods except for the above mentioned anatomical landmarks using method. For example, the detecting function 37a can detect the body part included in the volume data by using a region growing method based on voxel values.

The positional matching function 37b matches each position of multiple body parts in the subject included in the 3D image data with each position of multiple body parts in the human body included in the virtual patient data. Here, the virtual patient data is information which represents the standard positions in each of multiple body parts in the human body. Thus, the positional matching function 37b matches the body part of the subjects with the standard position of the body part, and stores the matching results in the memory 35. For example, the positional matching function 37b matches the virtual patient image which positioned the body parts of the virtual patient with the volume data of the subject.

Here, the virtual patient image is explained. The virtual patient image which is stored in the memory 35 is generated as an actual X-ray scanned image of the human body which has a standard body type defined by multiple combinations of parameters related to the body type, such as age, adult/child, male/female, weight, and height. Thus, the memory 35 stores the multiple virtual patient image data corresponding to the above mentioned parameter combinations. Here, the virtual patient image stored in the memory 35 also stores the associated anatomical landmarks. For example, in the human body, there are multiple anatomical landmarks which can be extracted by an image based on the morphological characteristics easily by using image processing such as a pattern recognition method etc. The position and arrangement of these multiple anatomical landmarks in the human body are roughly predetermined depending on parameters such as age, adult/child, male/female, weight, or height.

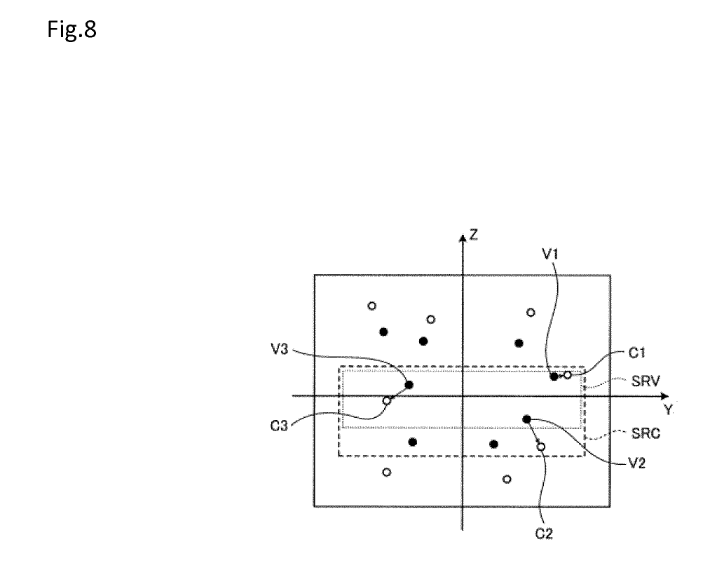

In the virtual patient image stored in the memory 35, these multiple anatomical landmarks are detected in advance, and the positional data of the detected landmarks are stored with ID codes of each landmark by associating with the virtual patient image data. FIG. 7 is a diagram of an example of a virtual patient image stored by the memory 35 according to the first embodiment. For example, the memory 35, as shown in the FIG. 7, stores the virtual patient image associated the ID code such as “V1”, “V2”, and “V3” for identifying anatomical landmarks with landmarks to the 3D human body including an organ or other body parts.

Thus, the memory 35 stores the coordinates of landmarks in the 3D human body with the corresponding ID code. For example, the memory 35 stores the coordinate of the landmarks by associating an ID code “V1” as shown in FIG. 7. Similarly, the memory 35 stores the ID code with coordinates of landmarks. In FIG. 7, as an organ, lung, heart, liver, stomach, kidney are indicated, but in fact, in this virtual patient image, further multiple organs are included, such as bone, vessel, neuron etc. Further, in FIG. 7, only landmarks associated with ID codes “3and ated with ID are indicated, however, further multiple landmarks are included in the human model image, in fact.

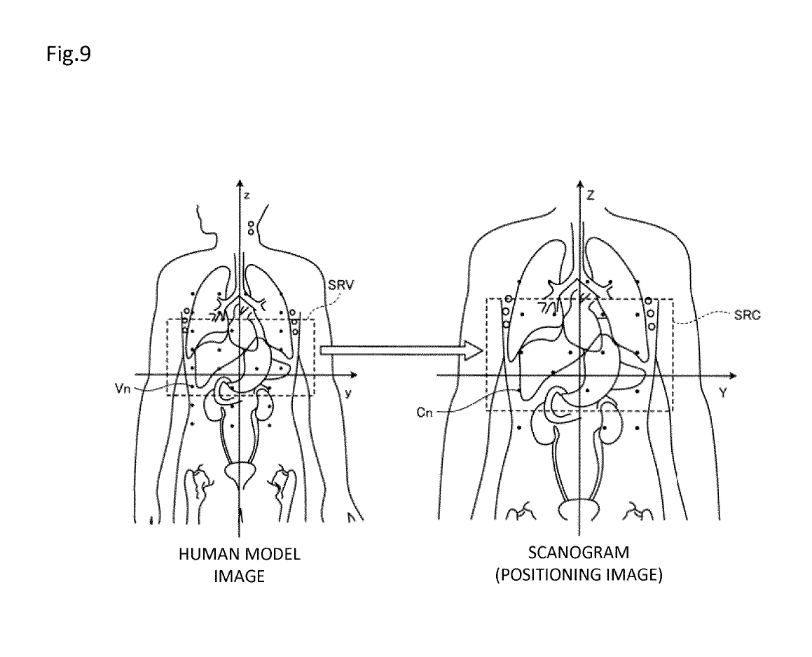

The positional matching function 37b associates the coordinates of the volume data with coordinates of the virtual patient image by matching the landmarks in the subject's volume data detected by the detecting function 37a with the above-mentioned landmarks in the virtual patient image by using ID codes. FIG. 8 is a diagram for explaining an example of a positional matching procedure by the positional matching function 37b according to the first embodiment. Here, in FIG. 8, an example is shown that the matching is performed by using 3 pairs of landmarks assigned the ID codes which represent the same landmarks between the landmarks detected by the scano image and detected by the virtual patient image. However, the embodiment is not limited to the above-mentioned embodiment. The matching can be performed by using an arbitrary number of pairs of landmarks.

For example, the positional matching function 37b, as shown in FIG. 8, associates the coordinates between the images by performing coordinate's transformation to minimize the positional deviation between the same landmarks, in case of matching the landmarks represented by ID codes “V1”, “V2”, and “V3” in the human model image with the landmarks represented by ID codes “C1”, “C2”, and “C3” in the scano image. For example, the positional matching function 37b, as shown in FIG. 8, calculates the below transformation matrix “H” to minimize the sum of the positional deviation “LS” between the anatomically same landmarks “V1 (x1, y1, z1), C1 (X1, Y1, Z1)”, “V2 (x2, y2, z2), C2 (X2, Y2, Z2)”, and “V3 (x3, y3, z3), C3 (X3, Y3, Z3)”.

LS=((X1,Y1,Z1)−H(x1,y1,z1))+((X2,Y2,Z2)−H(x2,y2,z2))+((X3,Y3,Z3)−H(x3,y3,z3))

The positional matching function 37b can transform the scan region designated on the virtual patient image to the scan region on the positioning image by using the calculated transformation matrix “H”. For example, the positional matching function 37b can transform the scan region “SRV” designated on the virtual patient image to the scan region “SRC” on the positioning image by using the transformation matrix, as shown in FIG. 8.

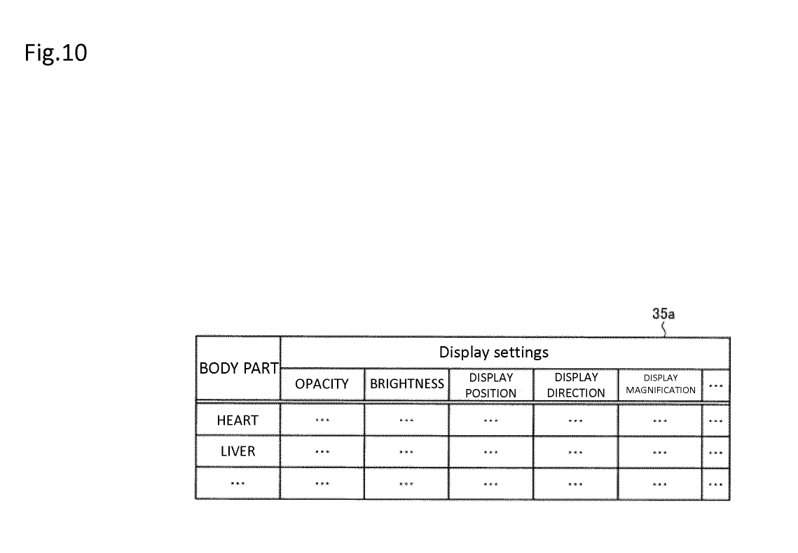

FIG. 9 is a diagram for explaining an example conversion of a scanning region by the coordinate conversion method according to the first embodiment. For example, as shown in the virtual patient image in FIG.9, if a user sets the scan region “SVR” on the human model image, the positional matching function 37b transforms the set scan region “SVR” to the “SRC” on the scano image by using the above-mentioned transformation matrix.

Thus, for example, scan region “SVR” set to include the landmarks corresponding to the ID code “Vn” on the virtual patient image can be transformed to the scan region “SRC” including the ID code “Cn” corresponding to the same landmarks on the scano image. Here, the above-mentioned transformation matrix “H” can be stored in the memory 35 in each subject and be used by reading out appropriately. Or, the above-mentioned transformation matrix “H” can be calculated every time the scano images are acquired. Thus, according to the first embodiment, by displaying the virtual patient image for designating the range at pre-set and planning the position and range on the virtual patient image, it is possible to set the position and range automatically corresponding to the planned position and range on the positioning image after positioning image (scano image) scanning.

Further, the positional matching function 37b can output the above-mentioned matching results as a virtual patient image which represent the positions of multiple body parts in the human body. Thus, the positional matching function 37b can store the matching results in the memory 35, by matching the position of multiple body parts in the subject included in 3D image data with the position of multiple body parts schematically represented in the human model image, by using the same processing with the above-mentioned matching processing.

Return to the explanation of FIG. 2, the processing circuitry 37 includes the input/output controlling function 37c, the generating function 37d, and the generating function 37e.

The processing circuitry 37 performs a control for displaying the image which depicts the intended body parts clearly by a simple operation, by using the information stored in the memory 35. This control is explained below in detail.

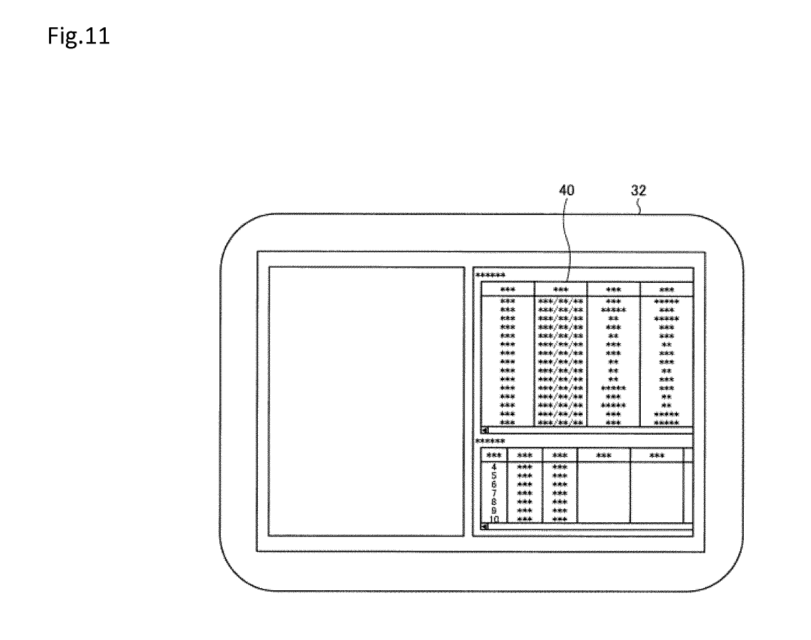

The memory 35, for example as shown in FIG. 10, stores the display setting list 35a which registers the display settings corresponding to each body part. The display setting list 35a is information (pre-set) which registers the display settings which include at least one of “opacity”, “brightness”, “display position”, “display direction”, and “display magnification” of the display image data. For example, the display setting list 35a is pre-registered by the user.

FIG. 10 is an example diagram of the displaying settings list according to the first embodiment. The exemplary display setting list 35a in FIG. 10 is information which registers the display settings in each body part for displaying the SVR (Shared Volume Rendering) image. As shown in FIG. 10, the display setting list 35a associates the “body part” with “display settings”.

Further, the example embodiment is explained, in a case the wide range of a region including multiple body parts can be scanned. Specifically, a case of a whole body scan including heart, lung, stomach, liver, small intestine, and large intestine of the subject is explained. However, the embodiment is not limited to the above-mentioned embodiment. The embodiment can be also applied in case of a region that targets only one body part for a scan.

The “body part” is information that indicates a target body part for displaying included in the volume data. For example, as a body part, the names of organs such as “heart” or “liver” are registered. Further, the body part is not limited to an organ. For example, information representing a region including multiple organs can be registered, such as head or abdomen. Or, information representing an area (detailed body part) of “heart”, such as “right atrium”, “right ventricular”, “left atrium”, and “left ventricular” can be registered.

The “display settings” is information for displaying an image corresponding to the target body part. For example, the display settings exemplary indicated in FIG. 10 are “opacity”, “brightness”, “display position”, “display direction”, and “display magnification”.

The “opacity” is information that indicates the degree of describing the back region (back side from the display) of each voxel of a target body part in the SVR image. For example, if the opacity is set as “100%”, the back region would not be described on the display. Further, if the opacity is set as “0%”, the region would not be described on the display.

Further, the “brightness” is information that indicates the brightness of the target body part's image. For example, the appropriate brightness is assigned to each voxel of the target body part by setting the appropriate brightness based on the standard CT value of each of the human body part.

Further, the “display position” is information that indicates a position (coordinate) of the described target body part. For example, as a display position, the center position of each body part (center of gravity) can be set. Thus, the center of the body part can be displayed on the display (or display region). Further, the display position is not limited to the center of the body part. An arbitrary position can be set as the display position. For example, the center of the boundary position between the aortic arch and heart can be set as a display position.

The “display direction” is information that indicates a direction of the described body part. For example, as a display direction, from the anterior to posterior direction can be set. Thus, the target body part can be displayed by the direction of a front-facing direction. Further, the display direction is not limited to the anterior to posterior direction. An arbitrary direction can be set as the display direction. For example, the tangential direction of a boundary position between the aortic arch and heart can be set as a display position.

The “display magnification” is information that indicates a magnification of the described target body part. For example, as a display magnification, the magnification that can include each body part in the display can be set. Thus, the totality of the target body part can be displayed. Further, the display magnification is not limited to the magnification that can include the totality of the target body part. The arbitrary magnification can be set. For example, the expanded image of the boundary position between the aortic arch and heart can be set for displaying.

Further, FIG. 10 is just an example, and the embodiment need not be limited to that example. For example, in FIG. 10, the display setting for displaying the SVR image is indicated, but the memory 35 can store the display settings for displaying a MPR image. Further, the items for display settings are not limited to opacity, brightness, display position, display direction, and display magnification. Other arbitrary items can be set as the display settings. For example, different items from the above-mentioned items can be set, or just a few of the above-mentioned items can be set. Further, for example, the display setting list 35a is not necessarily stored in the memory 35. For example, the display setting list 35a can be stored in an arbitrary device connected by the network 4. Thus, the display setting list 35a can be stored in a storage space connected with the processing circuitry 37 with a readable condition.

The input/output controlling function 37c accepts an operation to select the intended body part by a user, among the multiple body parts detected by the detecting function 37a. For example, the input/output controlling function 37c displays an image which displays the selectable multiple body parts detected by the detecting function 37a in the human model image. Further, the input/output controlling function 37c accepts an operation to select the intended body parts among the displayed selectable body parts on the human model image.

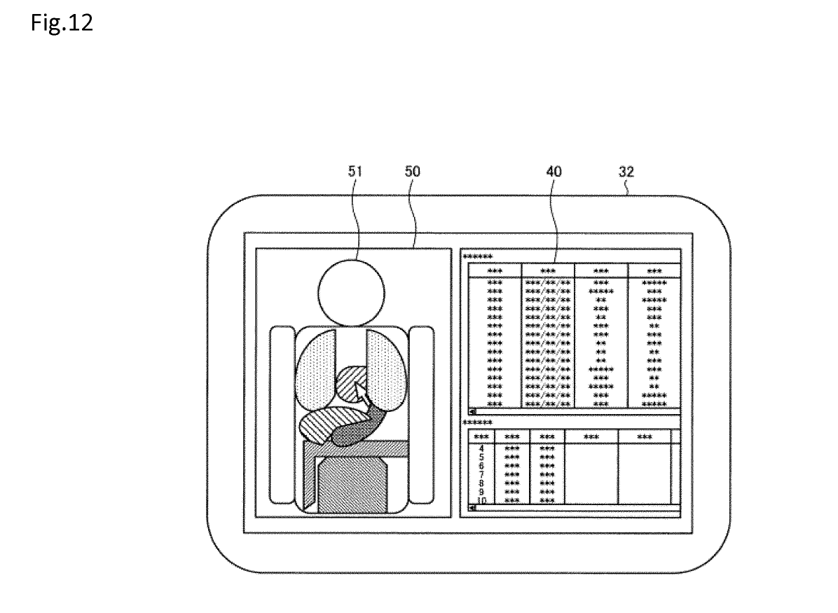

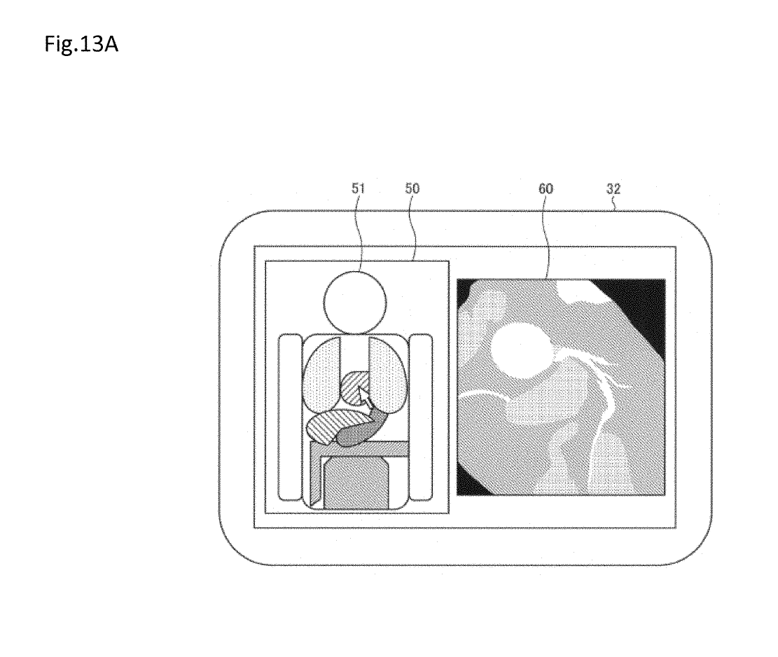

FIG. 11 and FIG. 12 are diagrams for explaining the processing by the input/output controlling function 37c according to the first embodiment. FIG. 11 and FIG. 12 show exemplary screens displayed on the monitor 32 when the target body part is selected by user.

As shown in FIG. 11, for example, the input/output controlling function 37c displays the inspection result list (File Utility) on the monitor 32 after the acceptance of the order to start diagnosis by a user. This inspection result list is associated with the information such as inspection ID, patient name, sexuality of patient, age, or body part of the inspection. Here, once the user operates to select the intended inspection result of a patient, the input/output controlling function 37c reads out the volume data and the detection results included in the selected inspection result from the memory 35. Further, the input/output controlling function 37c displays the screen for body part selection 50 based on the detection result of the body part (FIG. 12).

As shown in FIG. 12, the human model image 51 is displayed on the screen for body part selection 50. In this human model image 51, schematic images of each organ are described. Further, in the schematic images of each organ, the detection results of each organ detected by the detecting function 37a are corresponded. Here, the position matching of the detection results in each body part with the schematic images of each organ is performed by the above-mentioned positional matching function 37b.

Here, the human model image 51 displayed with the multiple body parts detected by the detecting function 37a can be selectable. In the example indicated in FIG. 12, the images of the heart, lung, stomach, liver, small intestine, or large intestine are displayed with a colored condition (on click). This means that the heart, lung, stomach, liver, small intestine, or large intestine have been detected by the detecting function 37a and these body parts are selectable by a user as target body parts for a display target. Further, by clicking the image of “heart” by moving the mouse cursor, the input/output controlling function 37c accepts the “heart” as a target body part.

Further, the input/output controlling function 37c accepts an operation to select the display method of the target body parts such as a 3D display (SVR image) or a 2d display (MPR image). This operation can be done by using different conventional ways, such as a keyboard operation or mouse operation.

In this way, the input/output controlling function 37c accepts operations to select the target body part on the human model image 51. Thereafter, the input/output controlling function 37c outputs the accepted information to the generating function 37d. For example, the input/output controlling function 37c outputs the information indicating the 3D displaying of the target body part “heart” to the generation program 37d, if the input/output controlling function 37c accepts the operation to display the target body part “heart” by 3D.

Here, FIG. 11 and FIG. 12 are just examples of this embodiment, and the embodiment is not limited to the examples of FIG. 11 and FIG. 12. For example, the human model image 51 is displayed by 2D in FIG. 11 and FIG. 12, but the human model image 51 also can be displayed by 3D. Further, the operation to select a body part is not limited to using the human model image 51. For example, a rendering image of the scanned subject, a list of body parts, or a human model image are available. Further, other embodiments are described later.

The generating function 37d generates display image data from the volume data based on the display settings corresponding to the selected body part by a selection operation. For example, the generating function 37d reads out the display settings corresponding to the selected body parts by the input/output controlling function 37c from the memory 35. Further, the generating function 37d generates the display image data by performing the rendering processing to the volume data by using read out display settings.

For example, the generating function 37d outputs display settings corresponding to “heart”, by referencing the display setting list 35a stored in the memory 35, if the generating function 37d accepts the information to display the target body part “heart” by 3D from the input/output controlling function 37c (FIG. 10). Further, the generating function 37d performs a rendering processing to the volume data of “heart” by using the read out display setting of “heart”. Specifically, the generating function 37d extracts a region of the volume data (slice image) including the heart region from the whole body volume data of the subject. Here, for example, the generating function 37d extracts the volume data including the heart area by taking a margin to the position (coordinate) of the heart detected by the detecting function 37a. Further, the generating function 37d performs segmentation to the extracted volume data and SVR processing by assigning the opacity of heart to each voxel data of a segmented heart region. Further, the generating function 37d processes the SVR image data generated by the SVR processing by using the brightness, display position, display direction, and display magnification corresponding to the heart. Thereafter, the generating function 37d generates SVR image data of the subject's heart as a display image data based on the display settings of heart.

In this way, the generating function 37d generates the display image data from the volume data based on the display settings corresponding to the target body part. Further, the generating function 37d outputs the generated display image data to the display controlling function 37e.

Here, the explanation of the above-mentioned generating function 37d is just an example, and the embodiment need not to be limited to above-mentioned explanation. As an example, the case of the SVR image data of heart is generated as display image data was explained, but the embodiment is not limited to the above. For example, if the generating function 37d accepts the information to display the heart by 2D, the generating function 37d references the display setting list 35a and generates the MPR image data, such as an axial image, sagital image, and coronal image crossing at right angle at the center of the heart. Thus, the generating function 37d generates the display image data describing the target body part clearly, by changing the processing depending on the registered display settings in the display setting list 35a, or the accepted operation of the input/output controlling function 37c.

The display controlling function 37e displays the display image data generated by the generating function 37d on the monitor 32. For example, once the display controlling function 37e accepts the SVR image data of the heart from the generating function 37d, the display controlling function 37e displays the accepted SVR image data on the monitor 32.

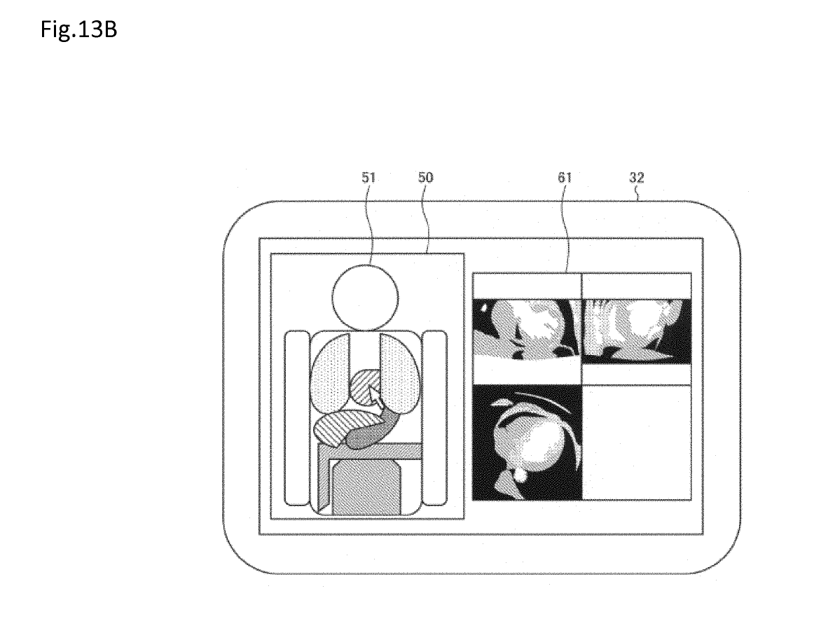

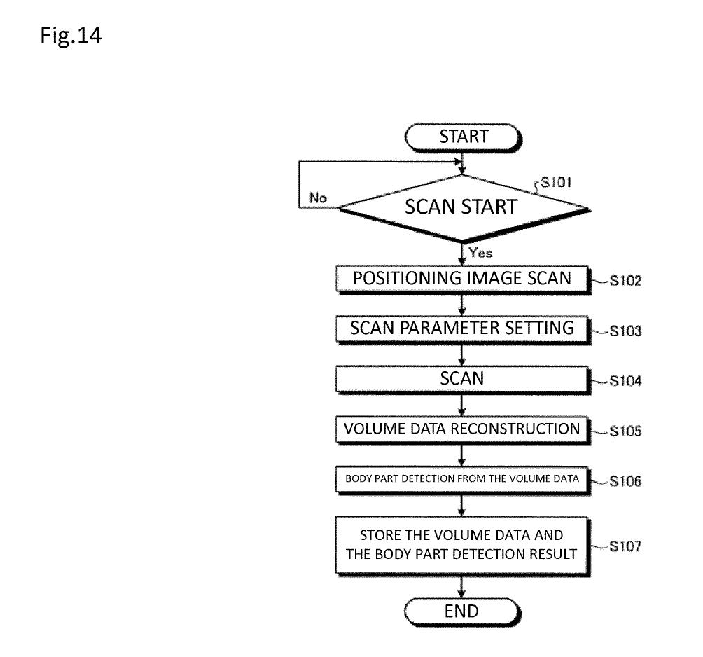

FIG. 13A and FIG. 13B are diagrams for explaining the processing of the display controlling function 37e according to the first embodiment. In FIG. 13A, the display image 60 displayed on the monitor 32 is exemplary indicated, when the operation for displaying the target body part “heart” by 3D (SVR image) was performed. In FIG. 13B, the display image 61 displayed on the monitor 32 is exemplary indicated, when the operation for displaying the target body part “heart” by 2D (MPR image) was performed.

As shown in FIG. 13A, for example, the display controlling function 37e accepts the generated SVR image data from the generating function 37d based on the display settings corresponding to the target body part “heart” by 3D. Further, the display controlling function 37e displays the display image 60 on the monitor 32 based on the accepted SVR image data of the heart. The display image 60 exemplary indicated in FIG. 13A is a SVR image describing an expansion image neighboring the boundary position of the heart and aortic arch.

Further, as shown in FIG. 13B, for example, the display controlling function 37e accepts each of the generated MPR image data from the generating function 37d based on the display settings corresponding to the target body part “heart” by 2D. Further, the display controlling function 37e displays the display image 61 on the monitor 32 based on the accepted each MPR image data of the heart. The display image 61 exemplary indicated in FIG. 13A is a MPR images crossing at the center of the heart, such as an axial image, sagital image, and coronal image. In this way, the display controlling function 37e displays the display image data generated by the generating function 37d.

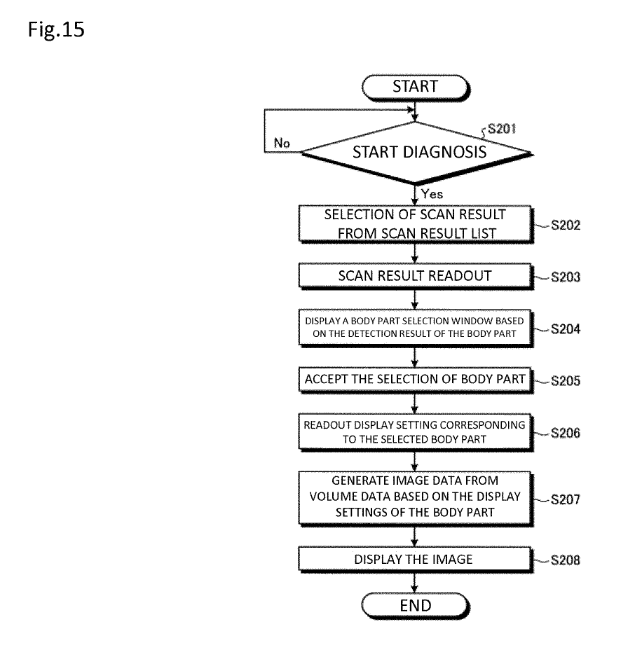

FIG. 14 and FIG. 15 are flowcharts indicating the processing order of the X-ray CT apparatus 1 according to the first embodiment. FIG. 14 indicates an exemplary processing procedure to generate volume data by scanning of the subject. Further, FIG. 15 indicates an exemplary processing procedure of diagnosis by using the volume data of the subject.

As shown in FIG. 14, the processing circuitry 37 judges whether or not the scan was started at step S101. For example, the processing circuitry 37 starts scanning and performs the processing described after the step S102 if the order to start scanning was inputted by the user. Here, if the step S101 was denied, No, the processing circuitry 37 would not start the scan. Thus, the processing circuitry 37 is set to a standby condition.

If the step S101 is Yes, the scan controlling circuitry 33 scans the positioning image (scano image) at step S102. Here, the positioning image can be a 2D image projected from 0 degrees or 90 degrees directions or a 3D image projected by whole circumference of the subject by helical scan or non-helical scan.

At step S103, the scan controlling circuitry 33 sets the scan conditions. For example, the scan controlling circuitry 33 accepts the various scan conditions on the positioning image by a user such as tube voltage, tube current, scanning region, slice thickness, and scan time. Further, the scan controlling circuitry 33 sets the accepted scan conditions.

At step S104, the scan controlling circuitry 33 performs the main scan. For example, the scan controlling circuitry 33 acquires the projection data of whole circumference of the subject by performing a helical scan or non-helical scan.

At step S105, the image reconstruction circuitry 36 reconstructs the volume data. For example, the image reconstruction circuitry 36 reconstructs the volume data of the subject by using the whole circumference projection data acquired by the main scan.

At step S106, the detecting function 37a detects the multiple body parts of the subject from the reconstructed volume data. For example, the detecting function 37a detects the body parts such as the heart, lung, stomach, liver, small intestine, or large intestine from the scanned volume data of the whole body of the subject.

At step S107, the detecting function 37a stores the detection results of the body parts and the volume data as the inspection results of the subject. For example, the detecting function 37a stores the information (detection result) of the detected body parts' position (coordinate) in the private tag (or the exclusive tag newly set for administrating the detection results) in the case of administrating the volume data of the subject based on the DICOM standard. Thereafter, the X-ray CT apparatus 1 finalizes the processing of indicated in FIG.14.

As shown in FIG. 15, the processing circuitry 37 judges whether the diagnosis is started or not at step S201. For example, the processing circuitry 37 performs the processing described after the step S202 if the order to start diagnosis was inputted by a user. Here, the processing circuitry 37 would not start the processing if the step S201 was denied, No. Thus the processing circuitry 37 is set to a standby condition.

If the step S201 is Yes, at step S202, the input/output controlling function 37c accepts the operation to select the intended inspection results from the inspection result list 40. For example, the input/output controlling function 37c displays the inspection result list 40 on the monitor 32 and accepts the operation to select the intended inspection result of the user on the inspection result list 40.

At step S203, the input/output controlling function 37c reads out the volume data included in the selected inspection results and the detection result from the memory 35. For example, the input/output controlling function 37c reads out the volume data included in the inspection result of a selected patient (subject) and the information (detection result) indicating the position (coordinate) of the multiple body parts from the volume data.

At step S204, the input/output controlling function 37c displays the screen for the body part selection 50 on the monitor 32 based on the detection result of read out body part's detection results. For example, the input/output controlling function 37c displays the colored human model image 51 which is detected by the detecting function 37a on the monitor 32.

At step S205, the input/output controlling function 37c accepts the selection of the body part. For example, the input/output controlling function 37c accepts the selection of “heart” as the target body part, if the click operation was performed on the position of “heart” on the human model image 51.

At step S206, the generating function 37d reads out the display settings corresponding to the selected body part. For example, the generation program 37d references the display setting list 35a stored in the memory 35, if the generating function 37d accepts the information to display the target body part “heart” by 3D, and reads out the display settings corresponding to the heart (FIG. 10).

At step S207, the generating function 37d generates the display image data from the volume data based on the read out body part's display setting. For example, the generating function 37d performs the rendering processing to the volume data corresponding to heart by using the read out display setting of heart. Thereafter, the generating function 37d generates the SVR image data of the subject's heart as the display image data based on the display settings of heart.

At step S208, the display controlling function 37e displays the display image data. For example, the display controlling function 37e displays the accepted SVR image data on the monitor 32 by accepting the SVR image data of heart from the generating function 37d.

Here, the processing procedures indicated in FIG. 14 and FIG. 15 are just examples. Therefore, the first embodiment is not necessarily limited to the embodiment indicated in FIG. 14 or FIG. 15. For example, the above-mentioned processing procedures are not necessarily performed in the above-mentioned orders. For example, the processing to detect the multiple body parts from the volume data (step S106) is not needed to be performed in the above-mentioned order. The processing at step S106, for example, can be performed in an arbitrary order unless the processing of step S106 is performed before the processing of step S204.

Further, all of the body part's display image data can be stored in the memory 35 by pre-performing generating processing of the display image data (step S207) by using the display settings of each body part to all of the body parts included in the volume data. In that case, if the selection of the body part is accepted (step S205), the processing (step S208) to display the display image data can be performed without performing the processing of the step S206 and the step S207. Further, the processing procedures indicated in FIG. 14 and FIG. 15 are not necessarily limited to the above-mentioned examples and can be performed by changing the processing orders unless contradictions would occur.

As above mentioned, in the X-ray CT apparatus 1 according to the first embodiment, the detecting function 37a detects each position of the subject's multiple body parts from the subject's volume data. Further, the input/output controlling function 37c accepts the operation to select the intended body parts from the detected multiple body parts. Further, the generating function 37d generates the display image data from the subject's volume data based on the display settings corresponding to the selected body part. Further, the display controlling function 37e displays the generated display image data. Thus, the X-ray CT apparatus 1 can display the image which describes the intended body part clearly by a simple operation.

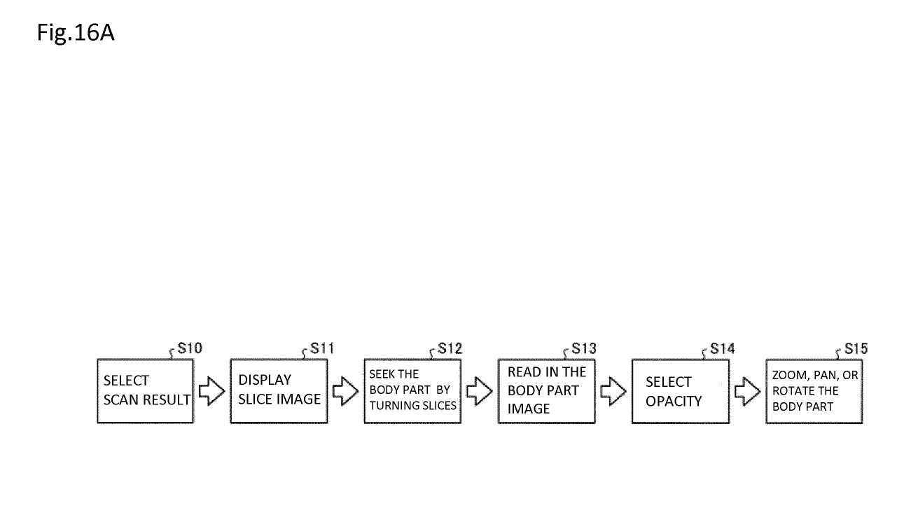

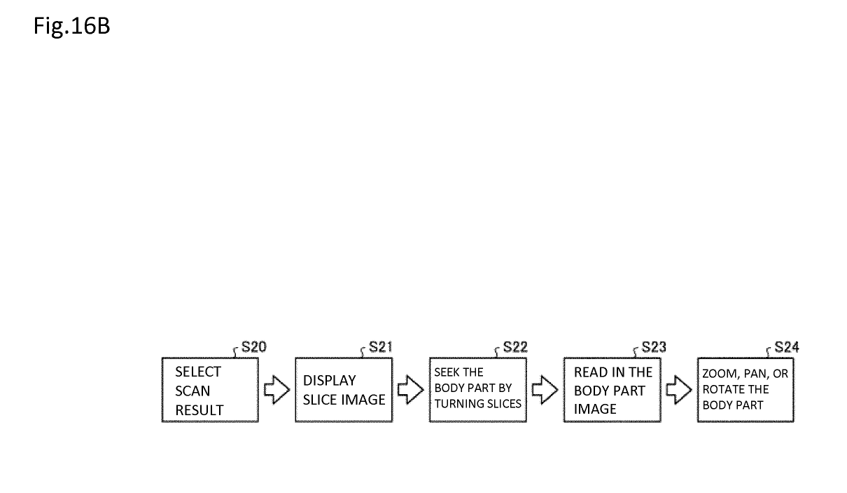

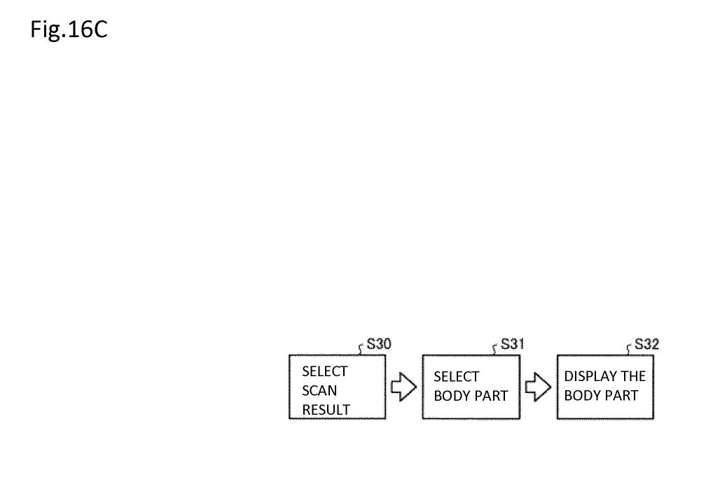

FIG. 16A-FIG. 16C are diagrams for explaining effects of the X-ray CT apparatus 1 according to the first embodiment. In FIG. 16A, the display procedure of a background display image (SVR image) is exemplary indicated. Further, in FIG. 16B, the display procedure of a background display image (MPR image) is exemplary indicated. Further, in FIG. 16C, the display procedure of the display image by the X-ray CT apparatus 1 according to the first embodiment is indicated.

In FIG. 16A, a user (a doctor or a radiologist) selects the inspection result of the intended subject (step S10), and the user displays the slice images of volume data (step S11). Further, the user seeks the slice position which describes the target body part, by switching and confirming the slice image (step S12). Further, the user displays the SVR image by loading the volume data (slice images) (step S13) including the target body part and selecting the opacity corresponding to the target body part (step S14). The SVR image displayed here is displayed by a certain condition (default condition) regardless of the target body part, and it is not necessarily displayed clearly. Therefore, the user may have to perform further operations such as zoom, pan, rotation of the target body part on the SVR image to describe the target body part clearly (step S15).

Further, in FIG. 16B, the user displays the MPR images of three orthogonality sections by performing step S20 to step S23 similarly as step S10 to step S13 in FIG. 16A. However, these displayed MPR images are also displayed by a certain condition regardless of the target body part. So the target body part is not necessarily displayed clearly. Therefore, to show the target body part clearly, the user may have to perform further operations such as zoom, pan, and rotation of the target body parts on the MPR image (step S24). In this way, the user may have to perform many manual operations in the background displaying procedures.

Further, in recent years, the amount of data of the image data (volume data) for processing is increasing in association with increasing in image resolutions. Therefore, the loading of the image data tends to need a longer time in each procedure shown in FIG. 16A and FIG. 16B. Therefore, to display the target body parts clearly by the series of display procedures indicated in FIG. 16A and FIG. 16B requires a longer time.

On the other hand, in the X-ray CT apparatus 1 according to the first embodiment, the user can obtain the display image (SVR image or MPR image) which describes the selected target body part based on the display settings (step S32), by selecting the intended patient's inspection results (step S30) and selecting the target body part from the selected inspection result (step S31). Therefore, for example, in the case of the body part including the heart, lung, stomach, liver, small intestine, or large intestine are scanned by a whole-body scan, the user only has to select the intended body part to display the image which describes the intended body part clearly. Further, the user can display the target body part clearly in a shorter time by decreasing the number of loadings, and as a consequence the display procedures are simplified in a case of handling high resolution image data.

Further, in the above explanation, the exemplary embodiment which accepts the selection operation of one body part as an intended body part was explained, but the embodiment is not limited to the above-mentioned embodiment. The input/output controlling function 37c can accept the operation to select more than one intended body part. Thus, the input/output controlling function 37c accepts the operation to select at least one body part within the multiple body parts detected by the detecting function 37a. Here, the processing of generating function 37d in the case of accepting the operation to select multiple body parts are described later in detail.

The first embodiment describes a case that accepts selection of an intended body part on the human model image 51, but the embodiment is not necessarily limited to this embodiment. For example, the X-ray CT apparatus 1 can accept the selection of target body part on a displayed list by displaying a list of body parts' name without the human model image 51.

For example, the input/output controlling function 37c can display a list of the multiple body parts' name detected by the detecting function 37a. Further, the input/output controlling function 37c can accept the operation to select an intended body part included in the displayed list.

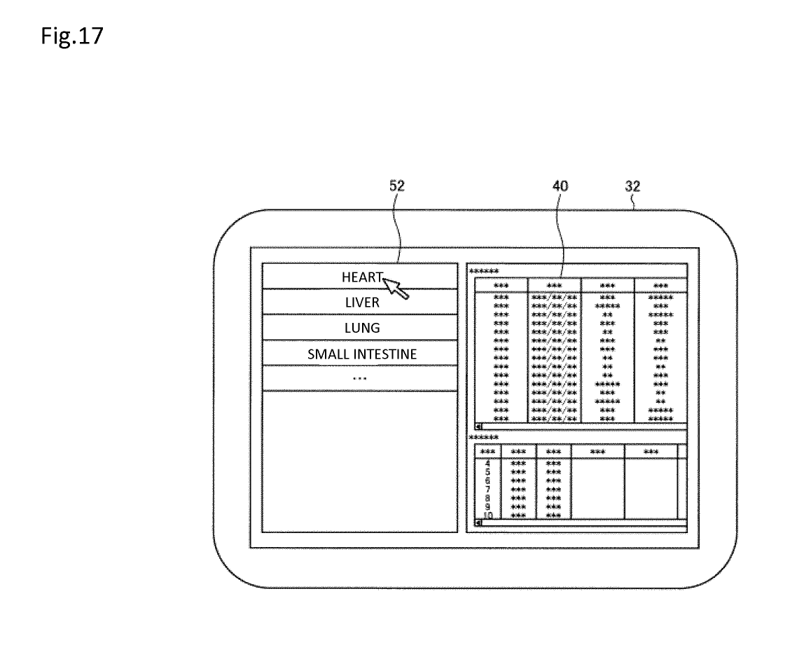

FIG. 17 is a diagram for explaining a procedure of input/output controlling function 37c according to a first variation of the first embodiment. In FIG. 17, an example list 52 is displayed on the monitor 32, in the case the target body part is selected by a user. Further, the exemplary indicated list in FIG. 17 is an example screen which is displayed in the case the intended inspection result of patient was selected in the exemplary indicated inspection result list in FIG. 11.

As shown in FIG. 17, the name of each organ detected by the detecting function 37a is described. As examples in FIG. 17, heart, liver, lung, and small intestine are displayed with an acceptable condition of a selection operation by the user. Thereafter, for example, if the user performs a click operation by moving the mouse cursor on the list of “heart”, the input/output controlling function 37c accepts the selection of the target body part as “heart”.

In this way, the input/output controlling function 37c accepts the operation to select the target body part on the list 52. Further the input/output controlling function 37c outputs the accepted information to the generating function 37d. Here, the other processings except for accepting the operation to select the target body part on the list 52 are the same as explained in the first embodiment.

Further, the X-ray CT apparatus 1 can accept the selection of the target body part on the scan image in other ways than by the human model image 51 or list 52.

For example, the input/output controlling function 37c displays an image which displays multiple body parts to be selectable as detected by the detecting function 37a based on at least the scano image (positioning image) of the subject or rendering image of the volume data. Further, the input/output controlling function 37c can accept an operation to select intended body parts within the body parts displayed in selectable manner on the displayed image.

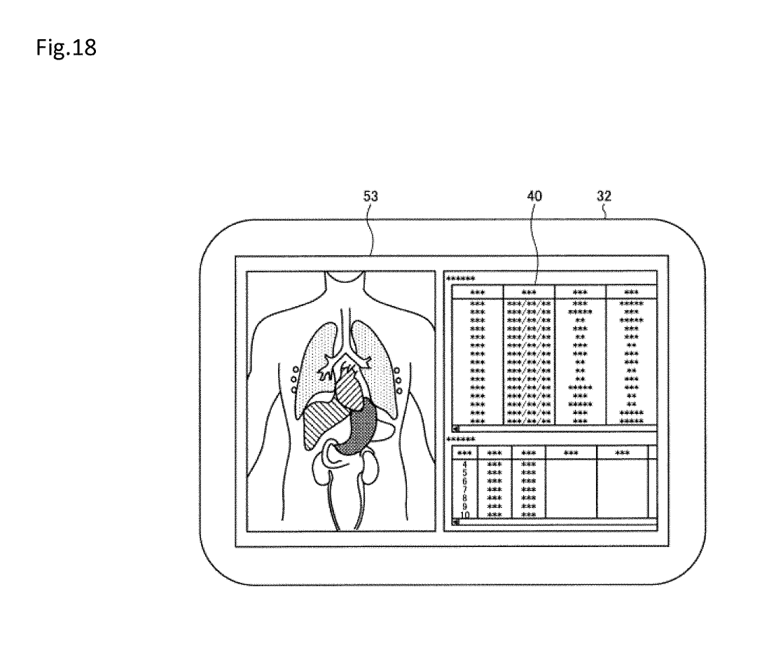

FIG. 18 is a diagram for explaining a procedure of an input/output controlling function according to a second variation of the first embodiment. In FIG. 18, the MPR image (coronal image) 53 which is displayed on the monitor 32 is exemplary indicated in the case the target body part was selected by the user. Here, the exemplary indicated MPR image 53 is an example screen displayed, in a case the intended patient's body part was selected on the exemplary indicated inspection result in FIG. 11.

As shown in FIG. 18, a section image of each organ described in the MPR image 53 is a coronal image of the subject's body. Here, the MPR image 53 is displayed such that the multiple body parts detected by the detecting function 37a can be in a selectable condition. In an example of FIG. 18, the section image of the heart, lung, stomach, liver, or small intestine included in the MPR image 53 is displayed by a colored condition (or a highlighting condition). This indicates that the heart, lung, stomach, liver, or small intestine are detected by the detecting function 37a and they can be selectable as the target body part for the display target by the user. Further, for example, if the user performs a click operation by moving the mouse cursor on the section image of “heart”, the input/output controlling function 37c accepts “heart” as the selected target body part.

In this way, the input/output controlling function 37c can accept the operation to select the target body part on the MPR image 53. Further, the input/output controlling function 37c outputs the accepted information to the generating function 37d. Here, the processing except for accepting the selection operation of the target body part on the MPR image 53 are the same as that explained in the first embodiment.

Further, in FIG. 18, a case in which MPR image 53 was applied as a scan image was explained, but the embodiment is not necessarily limited to that embodiment. As the actual scan image, for example, an SVR image based on other rendering processing or a scano image (positioning image) pre-scanned by a main scan also can be available.

Further, in the first embodiment and the first and second variations of the first embodiment, to accept the selection of the target body part, the case in which the human model image 51, list 52, or scan image (MPR image 53) are applied was explained, but these embodiments can be applied at the same time. For example, the input/output controlling function 37c can display the human model image 51 and list 52 on the display in parallel. In this case, the user can select the target body part by arbitrary methods within the human model image 51 and the list 52. Thus, the user can select the image of the intended body part on the human model image 51 or a certain column of the intended body part on the list 52.

In a second embodiment, after the acceptation of the body part's selection, cases that accept the selection of detailed body parts of the selected body part, or a case of selecting the display position, display direction, or display magnification of the selected body parts, are explained.

Further, the X-ray CT apparatus 1 according to the second embodiment includes the same components of the X-ray CT apparatus 1 exemplary indicated in FIG. 2, and a part of the input/output controlling function 37c and generating function 37d are only different. Here, in the description of the second embodiment, only the different points from the first embodiment are explained and the same explanation of the functions described in the first embodiment are omitted in this embodiment.

The input/output controlling function 37c displays a list displaying button for displaying a detail list which is a list of the name of the detailed body parts included in the selected body parts and an image displaying button for displaying a model image of the selected body part, in a case the input/output controlling function 37c accepts the operation to select the intended body part within the multiple body parts detected by the detecting function 37a. Further, if the list displaying button is selected, the input/output controlling function 37c displays the detail list and accepts the operation to select the detailed body part included in the detailed list. On the other hand, if the image displaying button is selected, the input/output controlling function 37c displays the model image of the body part and accepts the change of display position, display direction, or display magnification to the image.

The generating function 37d generates the display image data from the volume data based on the display settings corresponding to the selected detailed body part in the detailed list in the case the list displaying button is selected. Further, the generating function 37d generates the display image data from the volume data by using the changed display position, display direction, or display magnification in the case the image displaying button is selected.

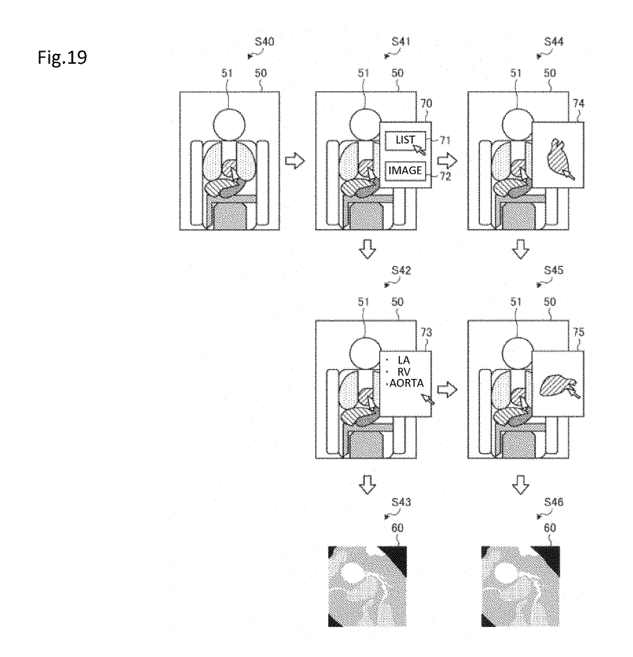

FIG. 19 is a diagram for explaining procedures of input/output controlling function 37c and generating function 37d according to the second embodiment. In FIG. 19, how the display images (on a User Interface) change in association with the selection operation of the target body part are indicated. Here, the human model image 51 displayed in step S40 of FIG. 19 is the same as that of the human model image 51 indicated in FIG. 12.

As shown in FIG. 19, if the user performs the click operation by moving the mouse cursor on the image of “heart” (step S40), the input/output controlling function 37c displays the mini-window 70 on the monitor 32 (step S41). This mini-window includes the list displaying button 71 and the image displaying button 72. Here, the list displaying button 71 is a button to display the detailed list of the name of the detailed body parts included in “heart”. Further, the image displaying button 72 is a button to display the schematic image of “heart”.

Here, if the user performs the click operation by moving the mouse cursor on the list displaying button 71, the input/output controlling function 37c switches the mini-window 70 to mini-window 73. This mini-window 73 is a list of the name of the detailed parts included in heart such as left atrium, right ventricular, vicinity of aorta, etc. The list of the detailed parts names displayed on the mini-window 73 is set in each body part, and stored in the memory 35 beforehand. In this mini-window 73, for example, if the user performs the click operation by moving the mouse cursor on the column of vicinity of “aorta”, the input/output controlling function 37c accepts the “aorta in the vicinity of heart” as the target part (step S42). Further, the input/output controlling function 37c outputs information displaying the target part “heart in the vicinity of aorta” to the generating function 37d.

The generating function 37d reads out the display setting corresponding to the “heart in the vicinity of aorta” by referencing the display setting list 35a, if the generating function 37d accepts the information to display the target part “heart in the vicinity of aorta” from the input/output controlling function 37c. Further, the generating function 37d performs the rendering processing (SVR processing) to the volume data of the “heart in the vicinity of aorta” by using the read out display setting corresponding to the “heart in the vicinity of aorta”. In consequence, the generating function 37d generates the SVR image in which “heart in the vicinity of aorta” is extracted clearly. Further, the display controlling function 37e displays the display image 60 on the monitor 32 based on the generated SVR image data from the generating function 37d (step S43).

On the other hand, if the user performs the click operation by moving the mouse cursor on the image displaying button 72, the input/output controlling function 37c switches the mini-window 70 to the mini-window 74 (step S44). In this mini-window 74, the schematic image of heart 75 is displayed (step S45). The schematic image 75 displayed in this mini-window 74 is set in each body part and stored in the memory 35 beforehand. In this mini-window 74, for example, if a move, rotation, or scaling of the schematic image 75 is performed by the mouse operation by user, the input/output controlling function 37c performs the selected operations such as the above-mentioned move, rotation, or scaling (step S45). Further, if the user recognizes that the schematic image 75 becomes the intended display position, display direction, or display magnification, the user performs the operation to decide the display position, display direction, or display magnification of the schematic image 75. If the display position, display direction, or display magnification of the schematic image 75 was decided, the input/output controlling function 37c accepts the order to display the target body part “heart” as the corresponding display position, display direction, or display magnification of the schematic image 75. Further, the input/output controlling function 37c outputs the order to display the target body part “heart” as the display position, display direction, or display magnification of the schematic image 75 to the generating function 37d.

The generating function 37d reads out the display settings corresponding to heart by referencing the display setting list 35a, if the generating function 37d accepts the order to display the target body part “heart” by a certain display position, display direction, or display magnification of the schematic image 75. Further, the generating function 37d generates the display image data of heart by using read out display settings of the heart. Here, the generating function 37d generates the display image data by using the display position, the display direction, or the display magnification of the schematic image 75, if the read out display setting from the display setting list 35a includes the display position, the display direction, or the display magnification. For example, the generating function 37d generates the display image data by using opacity and brightness read out from the display setting list 35a or display position, display direction, or display magnification of the schematic image 75. Further, the display controlling function 37e displays the display image 60 on the monitor 32 based on the display image data generated by the generating function 37d (step S46).

In this way, the X-ray CT apparatus 1 according to the second embodiment can accept the selection of the detailed part of the selected body part or designates the display position, display direction, or display magnification of the selected part, after the acceptation of the body part.

FIG. 19 is just an example and the embodiment is not limited to the example of FIG. 19. For example, in FIG. 19, by displaying the mini-window 70, it is explained that two cases were selectable, one case is to select the detailed body part (the case in which the list displaying button 71 was pushed), and the other case is to designate the displaying position, the displaying direction, and the displaying magnificent (the case in which the image displaying button 72 was pushed). However, the embodiment is not limited to the above described examples. For example, “the list displaying mode” to select the detailed body part, and “the image displaying mode” to designate the displaying position, the displaying direction, and the displaying magnificent can be pre-set.

For example, by the “list displaying mode”, if the user performs the click operation by moving the mouse cursor on the image of “heart” (step S40), the input/output controlling function 37c displays the mini-window 73 on the monitor 32 (step S42). Further, in the mini-window 73, for example, if the user performs the click operation by moving the mouse cursor near the “neighbor of aorta”, the input/output controlling function 37c accepts the “vicinity of aorta in heart” as the target body part. Thus, the input/output controlling function 37c can accept the detailed body part of the body part by using the “list displaying mode”.

Further, for example, in the “image displaying mode”, if the user performs the click operation by moving the mouse cursor on the image of “heart” (step S40), the input/output controlling function 37c displays the mini-window 74 on the monitor 32 (step S44). Further, in the mini-window 74, for example, if the user performs the moving, rotation, and scaling on the model image 75 by a mouse operation, the input/output controlling function 37c performs the moving, rotation, and scaling to the model image 75 corresponding to the performed operation (step S45).

If the operation to decide the moving, rotation, and scaling of the model image 75 is performed, the input/output controlling function 37c accepts the order to display the “heart” based on the moving, rotation, and scaling of the model image 75. Thus, the input/output controlling function 37c can accept the moving, rotation, and scaling of target body part “heart” by using the “image displaying mode”.

Further, in FIG. 19, the case that the body part was selected on the human model image 51 was explained, but the embodiment is not limited to that embodiment. For example, as explained in the first and second variations of the first embodiment, the body part can be selected on the list 52 or MPR image 53.

In a third embodiment, after the acceptation of the body part selection, the displaying image can be displayed based on displaying settings corresponding to the selected body part, and further, post-processing can be set automatically based on the selected body part, as now explained.

Here, the X-ray CT apparatus 1 according to the third embodiment includes similar configurations with the X-ray CT apparatus 1 exemplary described in FIG. 2, and only the processing circuitry 37 has different configurations. Therefore, in the third embodiment, only the different points from the first embodiment are explained, and the same functions explained in the first embodiment are omitted.

Here, the memory 35 according to the third embodiment further stores the post-processing list corresponding to the multiple body parts detected by the detecting function 37a in addition to the configuration explained in the first embodiment. The post-processing list stored by the memory 36 is described later in detail.

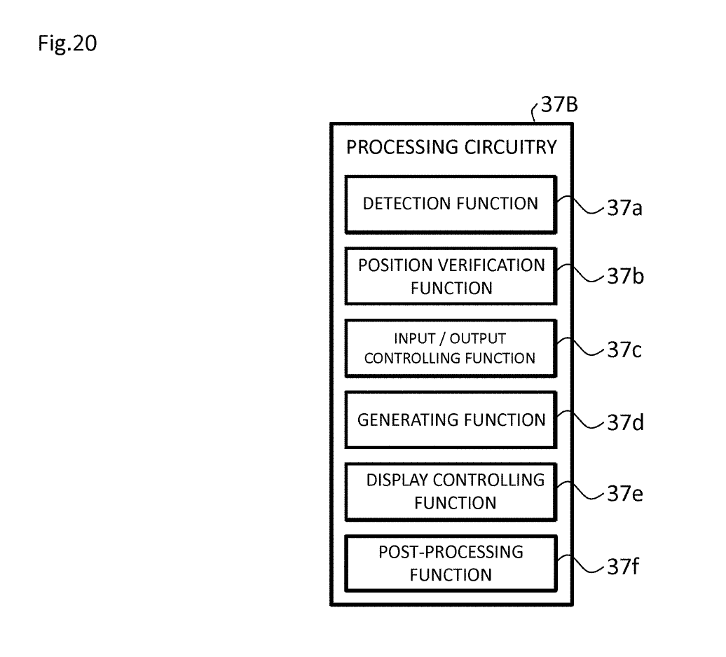

FIG. 20 is a configuration example of processing circuitry 37B according to the third embodiment.

As shown in FIG. 20, the processing circuitry 37B according to the third embodiment includes the post-processing program 37f in addition to the components of the processing circuitry 37 explained in the first embodiment.

The post-processing program 37f, within the detected multiple body parts by detecting function 37a, in the case the post-processing program 37f accepts the intended body part's selection from the user, detects the selected body part from the volume data and reads out the post-processing corresponding to the detected body part and performs the post-processing to the reconstructed volume data of the body parts. Here, the body part detection method from the volume data by the detecting function 37a is the same as described in the first embodiment.

Further, for example, the post-processing program 37f automatically performs the post-processing corresponding to the “heart” to the volume data detected by the detecting function 37a by referencing the post-processing list stored in the memory 35. Further, the post-processing program 37f displays the post-processing results on the monitor 32 thorough the display controlling function 37e after the post-processing.

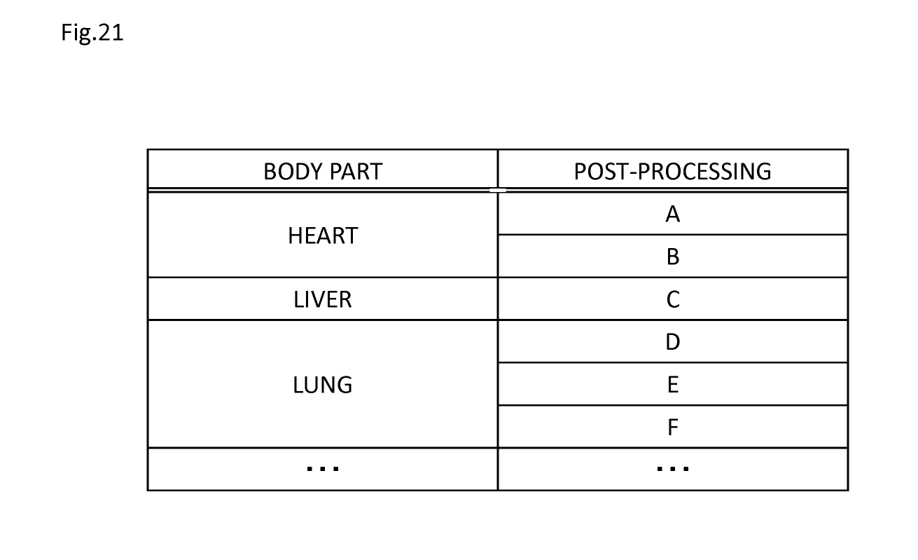

FIG. 21 is an exemplary diagram for explaining a post-processing list according to the third embodiment. As explained above, the post processing list is stored in the memory 35. As shown in FIG. 21, the memory 35 stores the multiple post-processing corresponding to the multiple body parts. Further, as shown in FIG. 21, multiple post-processing can be corresponded to one body part. For example, the post-processing corresponding to the body part “liver” is only “C”. On the other hand, the post-processing corresponding to the body part “heart” can be multiple options such as “A” and “B”.

Here, as examples of the post-processing corresponding to the “heart” indicated in FIG. 21, are a cardiac function analysis, a coronary analysis, and a calcified score analysis. As an example the post-processing corresponding to the “liver” is a perfusion analysis. As examples of the post-processing corresponding to the “lung” are a pulmonary function analysis and pulmonary nodule analysis.

That the post-processing program 37f may perform the post-processing automatically in the case of the post-processing corresponding to the selected body part is only one option. On the other hand, if the multiple post-processing corresponding to the selected body part exists, the post-processing program 37f displays the image to accept the selection operation involving the multiple post-processing through the display controlling function 37e. In this case, the post processing program 37f only performs the post-processing accepted by the user.

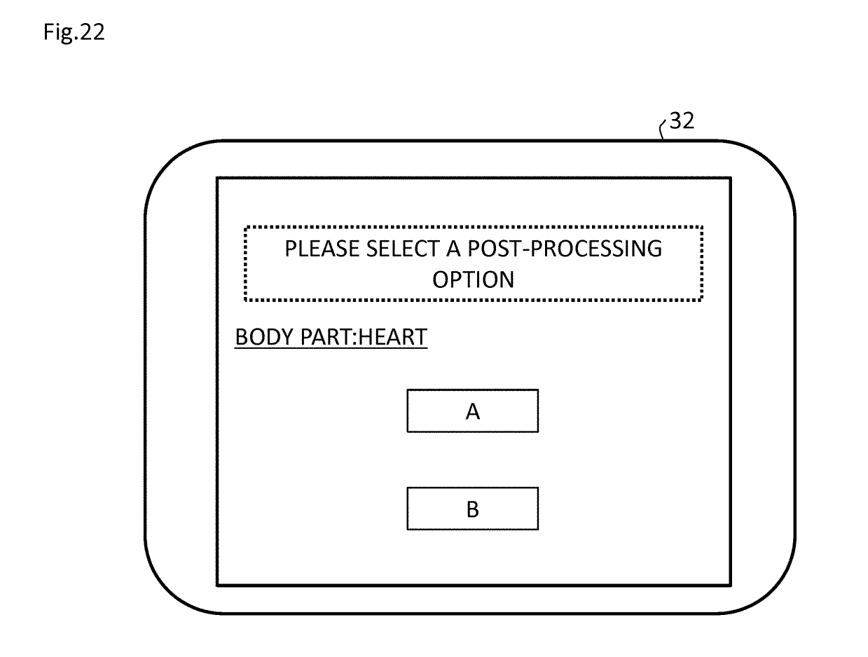

FIG. 22 is a diagram for explaining an example procedure of the selection display of the post-processing in the case multiple post-processings exist corresponding to the selected of the multiple body parts. For example, if the selected body part is “heart” and the corresponding post-processing includes multiple options, the post-processing program 37f displays the multiple post-processing options (A, B, and C) which can be performed, and accepts the selection thereof from the user.

Here, if the necessary data to perform the post-processing corresponding to the selected body part is lacking, the post-processing program 37f can display messages on the monitor 32 to inform the lack of necessary data to perform the post-processing through the display controlling function 37e. For example, to perform a brain blood flow analysis which is a post-processing corresponding to the “brain”, it is necessary to scan in multiple time phases by using contrast. Therefore, if there is no multiple time phase's volume data, the brain blood flow analysis cannot be performed. In this case, the post processing program 37f has to obtain multi-phase volume data to perform the post-processing through the display controlling function 37e.

Further, in the case there are multiple post-processings corresponding to the selected body part and the necessary data is lacking to perform the post-processing, the post-processing program 37f can display the post-processing options distinctively, that is, both the performable and non-performable options can be displayed distinctively on the monitor 32 through the display controlling function 37e. For example, within the multiple post-processing options, not performable post-processing options can be displayed by a lighter colored display.

Further, the post-processing program 37f outputs the post-processing results to the monitor 32 through the display controlling function 37e.

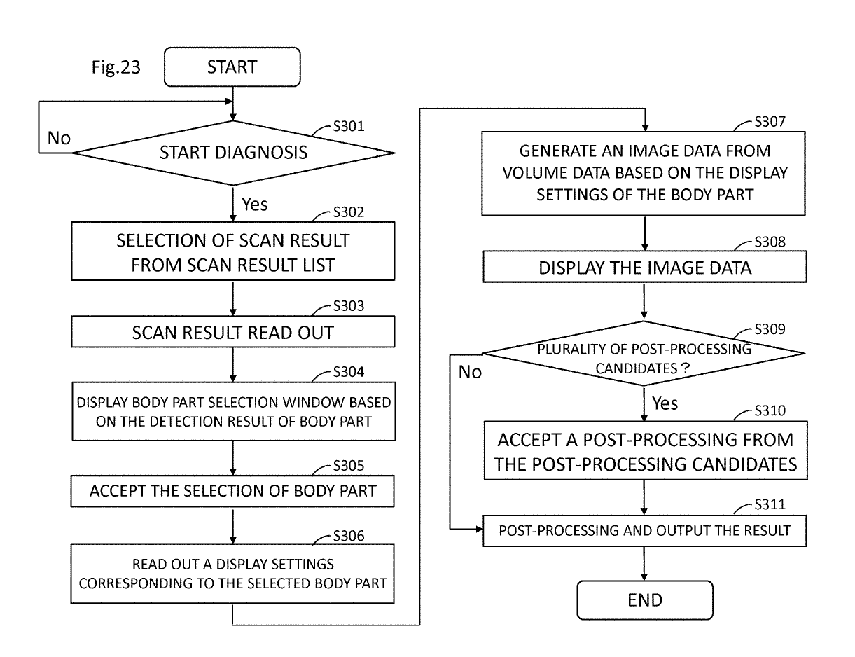

FIG. 23 is a flowchart for explaining an exemplary procedure by the X-ray CT apparatus 1 according to the third embodiment.

In the flowchart indicated in the FIG. 23, the steps S301 to S306 are the same as explained in steps S201 to S206 in FIG. 15 according to the first embodiment, so their similar explanation is omitted.

At step S307, the generating function 37d generates the display image data corresponding to the detected body part by the detecting function 37a based on the read out body part's display setting.

At step S308, the display controlling function 37e displays the display image data on the monitor 32.

At step S309, the post-processing program 37f loads the post-processing corresponding to the selected body part in step

S305 from the memory 35. Here, the post-processing program 37f performs the processing of step S310 if there are multiple post-processings corresponding to the selected body part. On the other hand, the post-processing program 37f performs the processing of step S311 if there is only one post-processing corresponding to the selected body part.

At step S310, the post-processing program 37f displays the selection screen for multiple post-processing options corresponding to the selected body part through the display controlling function 37e. The input/output controlling function 37c accepts the selection of intended post-processing within the multiple post-processing options by the user.

At step S311, the post-processing program 37f applies the post-processing accepted by the input/output controlling function 37c to the selected body part at step S305 and outputs the post-processing results to the monitor 32 through the display controlling function 37e.

Here, in the above-explained third embodiment, it was explained that the post-processing was performed as a function of the processing circuitry 37 in the console 30, but the embodiment need not be limited to the above-mentioned way. Alternatively, the post-processing can be performed by a workstation connected with the X-ray CT apparatus 1 through the network 4. That is, the workstation can perform the processing after the step S305 after it accepts the volume data from the X-ray CT apparatus 1.

Further, in the third embodiment, it was explained that the post-processing was performed after the acceptation of the body part selection and displaying of the display image data corresponding to the selected body part which was done by display settings. However, only the post-processing corresponding to the selected body part can be performed by omitting the display settings and displaying of display image data.

According to the above-explained third embodiment, after the acceptation of the body part selection, the post-processing can be performed automatically corresponding to the body part. Further, if multiple post-processings which correspond to the body part exist, selectable post-processing options can be shown to the user. Further, if the post-processing corresponding to the selected body part cannot be performed, those information can be informed to the user. In this way, it can be possible to decrease the burden of the user relating to the post-processing and to improve the work flow.

The embodiments can be performed by various different embodiments except for the above-mentioned embodiments.

In the above-mentioned embodiments, an example that the display image was generated by accepting the operation to select one intended body parts was explained, but the embodiments are not necessarily limited to the above-mentioned embodiments. For example, the X-ray CT apparatus 1 can display each display image data corresponding to each of the body part by accepting the operation to select more than one intended body part.

The input/output controlling function 37c can accept the operation to select more than one body part within the multiple body parts. For example, the input/output controlling function 37c can accept the operation in each to select “liver” and “pancreas” as a target body part.

The generating function 37d generates the display image data for more than one body part based on the display settings corresponding to the more than one body part. For example, the generating function 37d reads out the display settings corresponding to the target body part “liver” from the memory 35 and generates the display image data of liver based on the read out display setting of liver. Further, generating function 37d reads out the display settings corresponding to the target body part “pancreas” from the memory 35 and generates the display image data of pancreas based on the read out display setting of pancreas.

The display controlling function 37e displays the generated display image data corresponding to more than one body part to the different display areas. For example, the display controlling function 37e displays the generated display image data of liver and pancreas by the generating function 37d to the different windows. In this way, the X-ray CT apparatus 1 can display the each body part's display image data by accepting the operation to select more than one body parts as the intended body parts.

Further, for example, the X-ray CT apparatus 1 can display one display image data composed by more than one body part by accepting the operation to select more than one intended body part.

The input/output controlling function 37c can accept the operation to select more than one body part within the multiple body parts. For example, the input/output controlling function 37c accepts the operation to select “liver” and “pancreas” as the target body parts.

The generating function 37d generates the display image data including more than one body part based on the display settings corresponding to the display settings of a combination of more than one body part. For example, the generating function 37d reads out the display settings corresponding to the combination of “liver” and “pancreas” from the memory 35. Thereafter, the generating function 37d generates one display image data including both “liver” and “pancreas” based on the read out of the display settings of combination of “liver” and “pancreas”. In this case, the memory 35 stores the display settings corresponding to the combination of “liver” and “pancreas”. The display settings can be set to display both liver and pancreas clearly by adjusting the opacity, brightness, display position, display direction, and display magnification.

The display controlling function 37e can display the display image data including more than one generated body part. For example, the display controlling function 37e can display the one display image data including liver and pancreas generated by the generating function to the monitor 32. In this way, the X-ray CT apparatus 1 can display the display image data describing both liver and pancreas clearly.

In the above-mentioned embodiments, the following case was explained that the selectable body part which is detected by the detecting function 37a is displayed on the human model image 51 and the display image of the selected body part is generated and displayed. However, the embodiments need not be limited to the above-mentioned embodiment. For example, if there is a body part which cannot be detected by the detecting function 37a, the body part can be generated and displayed as the display image.

For example, if the “heart” cannot be detected in the volume data which scanned the subject's body part, nevertheless the “lung”, “stomach”, “liver”, “small intestine”, and “large intestine” may all be detected. In this case, the “heart” is displayed without color on the human model image 51. On the other hand, “lung”, “stomach”, “liver”, “small intestine”, and“large intestine” are displayed with color. In this case, once the user performs the click operation by moving the mouse cursor on the image of “heart”, the input/output controlling function 37c displays the confirmation message such as “Heart was not detected. Do you want to proceed to display this body part?”, or a similar phrase. Further, if the user permits the confirmation message, the input/output controlling function 37c accepts the selection of “heart” as the target body part.

Further, the generating function 37d generates the display image data from the volume data based on the display settings of the “heart”. In this case, for example, the generating function 37d estimates the position of the “heart” in the volume data based on the positional relations between the organ detected by the detecting function 37d and heart. Further, the generating function 37d generates display image data by extracting the volume data including the estimated region of the “heart” (slice images).

In this way, the X-ray CT apparatus 1 can generate and display the display image of the body part even if there is a undetected body part by the detecting function 37a.

Each function explained in the above embodiments and the variations of the embodiments can be performed by the medical imaging processing apparatus. In this case, the processing circuitry of the medical imaging processing apparatus is connected with the memory which stores volume data which has already detected the multiple body parts in the subjects. Further, the medical imaging processing apparatus has the input/output controlling function 37c, the generating function 37d, and the display controlling function 37e as same as shown in FIG. 2.

For example, the processing circuitry of the medical imaging processing apparatus acquires the volume data which detected the multiple body parts' position in the subject. Further, the processing circuitry accepts the operation to select at least one body part within the multiple body parts. Further, the processing circuitry generates the display image data from the volume data based on the display settings corresponding to the selected body parts. Thereafter, the processing circuitry displays the generated display image data.

Therefore, the medical imaging processing apparatus can display the image describing the intended body part with an easy operation. Here, the medical imaging processing apparatus was explained to include at least the input/output controlling function 37c, the generating function 37d, and the display controlling function 37e, but the embodiments need not be limited to the above-mentioned embodiment. For example, the processing circuitry of the medical imaging processing apparatus can further include the detecting function 37a and the positional matching function 37b. In this case, the memory connected with the processing circuitry of the medical imaging processing apparatus can store the volume data which is not detected for each position of the multiple body parts of the subject. Thus, the processing circuitry of the medical imaging processing apparatus can acquire the volume data from the memory and detect each position of the multiple body parts of the subject from the acquired volume data.

Further, in the above-mentioned embodiments and the variations of the embodiments, it was explained that the change of the relative position between gantry 10 and table 22 can be realized by the controlling of table 22, but the embodiment does not need to be limited to the above embodiment. For example, if the gantry 10 is a self propelled type, the change of the relative position between the gantry 10 and table 22 can be realized by controlling the drive of the gantry 10.

Further, each component of each apparatuses is indicated functionally and conceptually in the figures, so they do not have to be as exactly shown in the figures. Thus, each concrete aspect of each apparatus's dispersion and unification does not need to be limited to the indicated case in the figures and the all or part of the concrete aspect can be formed by dispersing or unifying functionally or physically depending on the burden or usages in arbitrary units. For example, the above-mentioned display setting list 35a does not need to be limited to the memory 35. For example, the display setting list 35a can be stored in an arbitrary storage device (external storage device) connected with the network 4. Further, all or an arbitrary part of each processing program performed in each apparatus can be realized by a CPU and a program which is analyzed in the CPU, or by hardware by wired-logic.

Further, the above-explained processing which is performed automatically in the embodiments and variations of the embodiments can be performed by a manual operation of all or part of itself. On the other hand, the operations explained that are performed manually, also can be performed automatically by a known method of all or a part of itself. Further, processing order, controlling order, name, or information which includes various data and parameter indicated in the specifications and drawings can be changed arbitrarily, except for any certain specially mentioned case.

Further, the image processing method explained in the above-mentioned embodiments and the variations of the embodiments can be realized by performing a prepared image processing program by using a personal computer or workstation. This image processing method can be distributed by a network such as internet. Further, this image processing method can be recorded in the readable storage medium by compute, such as a hard disc (HDD), flexible disk (FD), CD-ROM, MO, or DVD, and it can be performed by being read out from the storage medium by the computer.

According to at least one of the above-explained embodiments, the image describing the intended body part can be displayed clearly with a simple operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the embodiments.

What is claimed is:

1. A medical imaging diagnosis apparatus comprising:
a memory to store volume data of a subject and, for each of a plurality of body parts, respective display settings;
processing circuitry configured to:
select a body part based on an input operation,
determine a region within the volume data that contains the selected body part of the subject and excludes portions of the volume data not including the selected body part,
read out the display settings corresponding to the selected body part from the memory,
apply the read out display setting to the volume data based on the determined region,
generate a display image based on the determined region, and
display the display image on a monitor.

2. The medical imaging diagnosis apparatus according to claim 1, wherein
the display settings include at least one of brightness, opacity, display position, display direction, and display magnification.

3. The medical imaging diagnosis apparatus according to claim 1, wherein
the processing circuitry further displays a human model image which indicates the plurality of body parts on the monitor, and the input operation uses the human model image for selecting the body part.

4. The medical imaging diagnosis apparatus according to claim 1, wherein
the processing circuitry further displays a list which indicates a series of names of the plurality of body parts on the monitor, and the input operation uses the list for selecting the body part.

5. The medical imaging diagnosis apparatus according to claim 1, wherein
the processing circuitry further displays a scano image of the subject or a rendering image on the monitor, and the input operation uses the scano image or the rendering image for selecting the body part

6. The medical imaging diagnosis apparatus according to claim 1, wherein
the processing circuitry is further configured to:
display a detailed list which indicates a series of names of detailed body parts of the selected body part,
receive a selection of the detailed body part based on the list, and
apply the display settings to the selected detailed body part.

7. The medical imaging diagnosis apparatus according to claim 1, wherein
the processing circuitry is further configured to:
select a first body part and a second body part from the multiple body parts,
display a first model image of the selected first body part and a second model image of the selected second body part,
change at least a display position, a display direction, and/or a display magnification of the first model image and the second model image, and
generate the display image based on the volume data by using the changed display position, the changed display direction, and/or the changed display magnification.

8. The medical imaging diagnosis apparatus according to claim 1, wherein
the processing circuitry is further configured to:
select a first body part and a second body part from the multiple body parts,
detect a first region corresponding to the first body part and a second region corresponding to the second body part,
apply the display settings corresponding to the first region and second region,
generate a first display image of the first region and a second display image of the second region, and
display the first display image and the second display image.

9. The medical imaging diagnosis apparatus according to claim 1, wherein
the processing circuitry is further configured to:
select a first body part and a second body part from the multiple body parts, and
read out the display settings from the memory based on the combination of first body part and second body part.

10. The medical imaging diagnosis apparatus according to claim 1, wherein
the memory further stores post-processing information corresponding to each of the plurality of body parts, and
the processing circuitry is further configured to:
read out the post-processing information corresponding to the selected body part,
perform the read out post-processing to the display image data or the volume data, and
display a post-processing result on the display.

11. The medical imaging diagnosis apparatus according to claim 1, wherein
the processing circuitry is further configured to:
display a list of multiple post-processing operations corresponding to the plurality of body parts,
receive a selection of one of the post-processing operations from the list, and
applying the selected post-processing operation to the selected body part.

12. A medical imaging processing apparatus comprising:
processing circuitry configured to:
acquire volume data which includes detected multiple positions of multiple body parts,
select a display target's body part from multiple body parts by user,
generate a display image from the volume data based on display settings corresponding to the selected body part, and
display the display image on a monitor.
